(19) United States
(12) Patent Application Publication
(10) Pub. No.: US 2020/0106118 A1
(43) Pub. Date: Apr. 2, 2020

(54) Bimetallic thermally-regenerative ammonia-based battery system, flow battery system and using methods

(71) Applicant: TIANJIN UNIVERSITY, Tianjin (CN)

(72) Inventors: Weiguang WANG, Tianjin (CN); Hua TIAN, Tianjin (CN); Gequn SHU, Tianjin (CN); Dongxing HUO, Tianjin (CN)

(73) Assignee: Tianjin University

(21) Appl. No.: 16/702,582

(22) Filed: Dec. 4, 2019

Related U.S. Application Data
(63) Continuation of application No. PCT/CN2018/125988, filed on Dec. 31, 2018.

(30) Foreign Application Priority Data
Mar. 27, 2018 (CN) 201810260307.3
Mar. 27, 2018 (CN) 201820421038.X
Mar. 27, 2018 (CN) 201820421047.9
Mar. 27, 2018 (CN) 201820421842.8

(51) Int. Cl. H01M 8/18; H01M 4/36

(52) U.S. Cl. CPC H01M 8/182; H01M 4/368

(57) ABSTRACT

The invention discloses a bimetallic thermally regenerative ammonia-based battery system and using method for harvesting low-grade waste heat. In this battery, the electrodes are made of two different metals that can form ammine complexes, and the metal M₁ that has a more negative redox potential of M₁(NH₃)ₓ₁^{y1+}/M₁ is the negative electrode, and the metal M₂ that has a more positive redox potential of M₂^{y2+}/M₂ is the positive electrode, achieving high-voltage discharge and low-voltage charge at the same temperature. A closed-loop battery cycle consists of a discharge process, a charge process and two thermal regeneration processes. Deposition and corrosion reactions occur cyclically at the M₁ and M₂electrodes during successive charge and discharge processes. Thermal energy in waste heat is saved in the distilled ammonia, which is used to shift the redox couples for charging at lower voltage and stored in the battery as chemical energy.

### FIELD OF THE INVENTION

The present invention belongs to a thermal-electrochemical system, in particular to a bimetallic thermally-regenerative ammonia-based battery system and flow battery system with high discharge voltage and low charge voltage, and methods of their use are described.

### BACKGROUND OF THE INVENTION

Due to the inefficiency of energy utilization and transformation, huge amounts of untapped energy exists in our daily life and industrial processes in the form of low-grade waste heat (<100-130° C.), which is gradually recognized as a renewable energy source and converting it into useful electrical energy is an energy-saving and environmental protection technology. The solid-state thermoelectric generators (TEGs) based on semiconductor materials can convert thermal energy directly into electrical energy, but their material costs are extremely high and the produced electricity cannot be stored. Newly emerging liquid-based thermoelectrically converted batteries or systems may be more effective than previous methods for harvesting low-grade thermal energy. Among them, the thermally regenerative electrochemical cycles (TRECs) and thermo-osmotic energy conversion (TOEC) process achieve the highest thermoelectric conversion efficiency, but their low power density limits the feasibility of practical application. Except for efficiency,the power density is also a critical index to evaluate the conversion of low-grade thermal energy to electricity. Currently, single-metallic (Cu, Ag, Co, Ni) thermally-regenerative ammonia-based batteries (such as US2017/0250433A1 and WO2016/057894A1) output the highest power density of 115 W m⁻², but these battery voltages don't exceed 0.45 V, which fundamentally limits their power and energy densities.

### SUMMARY OF THE INVENTION

In view of the prior art, the present invention provides a bimetallic thermally regenerative ammonia-based battery system, a flow battery system and using methods for harvesting low-grade waste heat, achieving high-voltage discharge and low-voltage charge at the same temperature. These systems fundamentally increase the discharge voltage and output power density of the battery, and the charging voltage is less than the discharge voltage, thereby generating net energy and realizing thermoelectric conversion.

In order to solve the above problems, the first technical solution of the present invention is: a bimetallic thermally regenerative ammonia-based battery system, including a reactor composed of a first electrode chamber and a second electrode chamber, a separator interposed between the first electrode chamber and the second electrode chamber. The first electrode M₁ and the second electrode M₂ are placed in the first and second electrode chambers, respectively, where the reference electrodes are also placed separately. Both the first electrode M₁ and the second electrode M₂ are mainly composed of the metal M, which can form complexes with ammonia, and the electrode potential of M(NH₃)ₓ^{y+}/M is less than the electrode potential of M^{y+}/M. A loop is formed by wire connection between the first and second electrodes. It is characterized in that the first,electrode M₁ and the second electrode M₂ are respectively selected from different metals M, and M is taken from at least one of copper, silver, cobalt or nickel in a solid form and also includes zinc in a solid form particularly. The electrode potential M₁(NH₃)ₓ₁^{y+}/M₁ of the first electrode M₁ is smaller than the electrode potential M₂^{y2+}/M₂ of the second electrode M₂, and the electrode potential M₁^{y1+}/M₁ of the first electrode M₁ is smaller than the electrode potential M₂(NH₃)ₓ₂^{y2+}/M₂ of the second electrode M₂. The electrolyte in the first electrode chamber contains an ammonium salt and a salt of the first electrode M₁, and the electrolyte in the second electrode chamber contains an ammonium salt and a salt of the second electrode M₂.

The first electrode M₁ and the second electrode M₂ are composite electrodes and mainly consist of at least two of Ag, Cu, Co, Ni or Zn.

The first electrode M₁ and the second electrode M₂ are composite carbon electrodes coated with at least one of Ag, Cu, Co, Ni or Zn.

The reactor is provided with one or more seals to secure, seal, and prevent air from entering the reactor.

The second technical solution of the present invention is: a method of use of a bimetallic thermally regenerative ammonia-based battery system according to the first technical solution, comprising the steps of:
1) Adding ammonia to the first electrode chamber, thereby the battery discharging:
   (a) Oxidation reaction occurs on the first electrode M₁ in the first electrode chamber: M₁ (s)+x1NH₃ (aq)→M₁(NH₃)ₓ₁^{y1+}+y1 e⁻
   (b) Reduction reaction occurs on the second electrode M₂ in the second electrode chamber: M₂^{y2+} (aq)+y2 e⁻→M₂ (s);
2) After the end of the discharge, the waste heat is used to separate the NH₃ in the first electrode chamber: M₁(NH₃)ₓ₁^{y1+} [symbol] M₁^{y1+} (aq)+x1 NH₃ (g);
   The separated NH₃ is passed into the second electrode chamber, and the cathode and anode chambers are switched;
3) Charging:
   (a) Reduction reaction occurs on the first electrode M₁ in the first electrode chamber: M₁^{y1+} (aq)+y1 e⁻→M₁ (s)
   (b) Oxidation reaction occurs on the second electrode M₂ in the second electrode chamber: M₂ (s)+x2 NH₃ (aq)→M₂(NH₃)ₓ₂^{y2+}+y2 e⁻;
4) After the end of the charge, the waste heat is used to separate the NH₃ in the second electrode chamber: M₂(NH₃)ₓ₂^{y2+} [symbol] M₂^{y2+} (aq)+x2 NH₃ (g);
   The separated NH₃ is passed into the first electrode chamber, and the cathode and anode chambers are switched again;
   Start the second discharge cycle and repeat steps 1) to 3) above.

When the first electrode M₁ or the second electrode M₂ is Cu, Co, Ni or Zn, the electrolyte in their respective electrode chamber is ammonium sulfate ((NH₄)₂SO₄) and the corresponding metal sulfate (MSO₄).

When the first electrode M₁ or the second electrode M₂ is Cu, Co, Ni or Zn, the electrolyte in their respective electrode chamber is ammonium nitrate (NH₄NO₃) and the corresponding metal nitrate (M(NO₃)₂).

When the first electrode M₁ or the second electrode M₂ is Cu, Co, Ni or Zn, the electrolyte in their respective electrode chamber is a mixture of ammonium sulfate ((NH₄)₂SO₄), ammonium nitrate (NH₄NO₃) and the corresponding metal sulfate (MSO₄) and nitrate (M(NO₃)₂).

When the first electrode M₁ or the second electrode M₂ is Ag, the electrolyte is ammonium nitrate (NH₄NO₃) and silver nitrate (AgNO₃).

The first electrode M₁ or the second electrode M₂ is flow electrode.

An oxygen-free inert gas is introduced into the electrolyte to remove oxygen and inhibit electrode corrosion.

The third technical solution of the present invention is: a bimetallic thermally regenerative ammonia-based flow battery system,comprising at least one cell module, a first electrolyte tank, a second electrolyte tank, and two pumps between the cell module and the electrolyte tanks connected by pipelines. Electrolytes are stored in the first electrolyte tank and the second electrolyte tank, and a reference electrode is disposed between the pump and the cell module. The cell module is mainly composed of a first electrode Mi, a second electrode M₂, a first electrode chamber, a second electrode chamber, and a separator interposed between the first and second electrode chambers. Both the first electrode M₁ and the second electrode M₂ are mainly composed of the metal M, which can form complexes with ammonia, and the electrode potential of M(NH₃)ₓ^{y+}/M is less than the electrode potential of M^{y+}/M. A loop is formed by wire connection between the first and second electrodes. The first and second electrolyte tanks are located on two sides of the cell module, respectively, and the electrolytes in the first and second electrode chambers are continuously flowing. It is characterized in that the first electrode M₁ and the second electrode M₂ are respectively selected from different metals M, and M is taken from at least one of copper, silver, cobalt or nickel in a solid form and also includes zinc in a solid form particularly. The electrode potential M₁(NH₃)ₓ^{x1+}/M₁ of the first electrode M₁ is smaller than the electrode potential. M₂^{y2+}/M₂ of the second electrode M₂, and the electrode potential M₁^{y1+}/M₁ of the first electrode M₁ is smaller than the electrode potential M₂(NH₃)ₓ₂^{y2+}/M₂ of the second electrode M₂. The electrolyte in the first electrolyte tank contains an ammonium salt and a salt of the first electrode M₁, and the electrolyte in the second electrolyte tank contains an ammonium salt and a salt of the second electrode M₂.

The first electrode M₁ and the second electrode M₂ are composite electrodes and mainly consist of at least two of Ag, Cu, Co, Ni or Zn.

The first electrode M₁ and the second electrode M₂ are composite carbon electrodes coated with at least one of Ag, Cu, Co, Ni or Zn.

The cell module is provided with one or more seals to secure, seal, and prevent air from entering the cell module.

The fourth technical solution of the present invention is: a method of use of a bimetallic thermally regenerative ammonia-based flow battery system according to the third technical solution, comprising the steps of:
1) Adding ammonia to the first electrolyte tank, thereby the battery discharging:
   (a) Oxidation reaction occurs on the first electrode M₁ in the first electrode chamber: M₁ (s)+x1 NH₃ (aq)→M₁(NH₃)ₓ₁^{y1+}+y1 e⁻
   (b) Reduction reaction occurs on the second electrode M₂ in the second electrode chamber: M₂^{y2+} (aq)+y2 e⁻M₂ (s);
2) After the end of the discharge, the waste heat is used to separate the NH₃ in the first electrolyte tank: M₁(NH₃)ₓ₁^{Y1+} [symbol] M₁^{y1+} (aq)+x1 NH₃ (g);
   The separated NH₃ is passed into the second electrolyte tank, and the cathode and anode chambers are switched;
3) Charging:
   (a) Reduction reaction occurs on the first electrode M₁ in the first electrode chamber: M₁^{y1+} (aq)+y1 e⁻→M₁ (s)
   (b) Oxidation reaction occurs on the second electrode M₂ in the second electrode chamber: M₂ (s)+x2 NH₃ (aq)→M₂(NH₃)ₓ₂^{y2+}+y2 e⁻;
4) After the end of the charge, the waste heat is used to separate the NH₃ in the second electrolyte tank: M₂(NH₃)ₓ₂^{y2+} [symbol] M₂^{y2+} (aq)+x2 NH₃ (g);
   The separated NH₃ is passed into the first electrolyte tank, and the cathode and anode chambers are switched again;
   Start the second discharge cycle and repeat steps 1) to 3) above.

When the first electrode M₁ or the second electrode M₂ is Cu, Co, Ni or Zn, the electrolyte in their respective electrolyte tank is ammonium sulfate ((NH₄)₂SO₄) and the corresponding metal sulfate (MSO₄).

When the first electrode M₁ or the second electrode M₂ is Cu, Co, Ni or Zn, the electrolyte in their respective electrolyte tank is ammonium nitrate (NH₄NO₃) and the corresponding metal nitrate (M(NO₃)₂).

When the first electrode M₁ or the second electrode M₂ is Cu, Co, Ni or Zn, the electrolyte in their respective electrolyte tank is a mixture of ammonium sulfate ((NH₄)₂SO₄), ammonium nitrate (NH₄NO₃) and the corresponding metal sulfate (MSO₄) and nitrate (M(NO₃)₂).

When the first electrode M₁ or the second electrode M₂ is Ag, the electrolyte is ammonium nitrate (NH₄NO₃) and silver nitrate (AgNO₃).

The first electrode M₁ or the second electrode M₂ is flow electrode.

The first electrode chamber and the first electrolyte tank are connected.

The second electrode chamber and the second electrolyte tank are connected.

An oxygen-free inert gas is introduced into the first or second electrolyte tanks to remove oxygen and inhibit electrode corrosion.

Compared with existing single-metallic (Cu, Ag, Co, Ni) thermally-regenerative ammonia-based batteries (such as US2017/0250433A1 and WO2016/057894A1), the present invention of the bimetallic thermally regenerative ammonia-based battery system, the flow battery system and using methods have the following beneficial effects:
1) A closed-loop battery cycle consists of a discharge process, a charge process and two thermal regeneration processes, which can utilize more waste heat energy than the single-metallic thermally-regenerative ammonia-based battery that only has a discharge process and a thermal regeneration process.
2) The positive and negative electrode materials are made of different metals, and the metal Zn is used as the battery negative electrode material, thereby markedly improving the discharge voltage and output power density. Moreover, the discharge voltage is greater than the charge voltage, thereby generating net energy and realizing thermoelectric conversion.(For example, the discharge voltage of Ag/Zn-TRABreaches 1.84V, and its charging voltage is only 1.13V; the discharge voltage of Cu/Zn-TRABreaches 1.38V, and its charging voltage is 0.72V).
3) Taking Cu/Zn-TRAB as an example, the maximum power density after concentration optimization can reach 525 W m⁻²-electrode (120 W m⁻²-membrane), which is 4.5 times that of Cu-TRAB. In addition, the voltage, current, and power density of the entire battery system can be boosted by connecting multiple batteries in series or parallel. In successive regeneration cycles, the maximum power density can remain stable. By optimizing the thermal regeneration process, a thermoelectric conversion efficiency of 0.95% can be achieved (10.7% relative to the Carnot efficiency).
4) Bimetallic thermally regenerative ammonia-based flow battery system, taking Cu/Zn-TRAFB as an example, has a more compact battery structure, which can realize continuous power output and enhance the using efficiency of the ion exchange membrane. By optimizing the concentration and flow rate, Cu/Zn-TRAFB can achieve the maximum power density of 280 W m⁻²-membrane, which is significantly higher than Cu/Zn-TRAB. After the optimization of thermal regeneration process, a thermoelectric conversion efficiency of 1.64% can be obtained (27% relative to the Carnot efficiency). The Cu/Zn-TRAFB system also shows good scalability and system stability.
5) Bimetallic thermally regenerative ammonia-based batteries or flow batteries offer more options, and there are some other promising B-TRAB or B-TRAFB systems, such as the Ag/Zn-TRAB or Ag/Zn-TRAFB that has greater power density due to the highest discharging voltage of 1.84 V, Ag/Cu-TRAB or Ag/Cu-TRAFB that has greater net energy density and energy conversion efficiency due to the lowest theoretical charging voltage of 0.03 V, and Co/Ni-TRAB or Co/Ni-TRAFB that is charge-free.

### BRIEF DESCRIPTION OF THE DRAWINGS

FIG. 1(a) is a potential diagram of the redox couples of bimetallic thermally regenerative ammonia-based batteries (B-TRABs);

FIG. 1(b) is a schematic diagram of the Cu—Zn bimetallic thermally regenerative ammonia-based battery (Cu/Zn-TRAB) for converting waste heat energy into electricity;

FIG. 1(c) is a schematic diagram of the Cu—Zn bimetallic thermally regenerative ammonia-based flow battery (Cu/Zn-TRAFB) for converting waste heat energy into electricity;

FIG. 2(a) is a photograph of the laboratory set-up of a Cu/Zn-TRAB during discharge;

FIG. 2(b) is a photograph of the laboratory'set-up of a Cu/Zn-TRAB during charge;

FIG. 2(c) is an exploded view drawing of the test device of a Cu/Zn-TRAB;

FIG. 3 is a schematic of the distillation model for ammonia separation from the anolyte based on Aspen HYSYS;

FIG. 4(a) is a graph showing the effect of current density on power density and battery voltage during Cu/Zn-TRAB discharge and charge (using 0.1 M Cu(II) and 1 M (NH₄)₂SO₄ in the catholyte, and 0.1 M Zn(II), 1 M (NH₄)₂SO₄ and 2 M NH₃ in the anolyte during discharge tests; 0.1 M Zn(II) and 1 M (NH₄)₂SO₄in the catholyte, and 0.1 M Cu(II), 1 M (NH₄)₂SO₄ and 2 M NH₃ in the anolyte during charge tests);

FIG. 4(b) is a graph showing the effects of current density on electrode potentials during Cu/Zn-TRAB charge;

FIG. 5 shows the SEM images of the zinc electrode after 30 minutes of the constant-current charge tests of Cu/Zn-TRAB with different current densities: (a) 100 A m^{—2} (b) 200 A m⁻² (c) 400 Am⁻² (using 0.1 M Zn(II) and 1 M (NH₄)₂SO₄ in the catholyte, and 0.1 M Cu(II), 1 M (NH₄)₂SO₄ and 2 M NH₃ in the anolyte);

FIGS. 6(a) and (b) show the effects of different Cu²⁺/Zn²⁺ and NH₃ concentrations on Cu/Zn-TRAB power density and electrode potentials using 1M (NH₄)₂SO₄as the supporting electrolyte;

FIGS. 6(c) and (d) show the effects of different (NH₄)₂SO₄ concentrations on Cu/Zn-TRAB power density and electrode potentials using0.1 M Cu(II) in the catholyte, and 0.1 M Zn(II) and 2 M NH₃ in the anolyte;

FIGS. 7(a) and (b) show the effects of different Cu²⁺/Zn²⁺ concentrations on Cu/Zn-TRAB power density and electrode potentials using 1 M or 2 M NH₃ in the anolyte and 1M (NH₄)₂SO₄as the supporting electrolyte;

FIGS. 8(a) and (b) show the effects of different (NH₄)₂SO₄ concentrations on electrolyte conductivity and pH using0.1 M Cu(II) in the catholyte, and 0.1 M Zn(II) and 2 M NH₃ in the anolyte;

FIGS. 9(a), (b) and (c) show the power density, voltage and electrode potentials of two Cu/Zn-TRABs that were connected in series and parallel, compared with a single Cu/Zn-TRAB operating during the discharge (Electrolytes contained 0.1 M Cu(II) and 1 M (NH₄)₂SO₄ in the catholyte, and 0.1 M Zn(II), 1 M(NH₄)₂SO₄ and 2 M NH₃ in the anolyte);

FIGS. 10(a), (b) and (c) show the voltage and net energy density, discharge power density and electrode potentials of Cu/Zn-TRAB in three successive regeneration cycles at a current density of 100 A m⁻² (The initial electrolyte contained 0.1 M Cu(II) and 1 M (NH₄)₂SO₄ in the catholyte and 0.1 M Zn(II), 1M (NH₄)₂SO₄ and 2 M NH₃ in the anolyte. After discharging and charging, the anolyte effluent was regenerated and then operated in next process. “CCD” and “CCC” represent “constant current discharge” and “constant current charge”, respectively);

FIGS. 11(a) and (b) show XRD analysis diagrams of the precipitates produced during the thermal regeneration of anolyte effluent after the charge and discharge processes, respectively;

FIG. 12 shows the SEM images of the zinc electrode and corresponding EDS spectrums after the constant-current discharge tests of Cu/Zn-TRAB at current densities of 100 Am⁻² ((a) and (c)) and 200 A m⁻²((b) and (d));

FIGS. 13(a), (b) and (c) show the voltage and net energy density, discharge power density and electrode potentials of Cu/Zn-TRAB in three successive regeneration cycles at a current density of 200 A m⁻² (The initial electrolyte contained 0.1 M Cu(II) and 1 M (NH₄)₂SO₄ in the catholyte and 0.1 M Zn(II), 1M (NH₄)₂SO₄ and 2 M NH₃ in the anolyte. After discharging and charging, the anolyte effluent was regenerated and then operated in next process. “CCD” and “CCC” represent “constant current discharge” and “constant current charge”, respectively);

FIGS. 14(a), (b) and (c) show the voltage and maximum net energy density, discharge power density and electrode potentials of Cu/Zn-TRAB in two successive regeneration cycles at a constant discharging load of 12Ω SZ (external resistance) and a constant charging current density of 100 A m⁻² (The initial electrolyte contained 0.1 M Cu(II) and 1 M (NH₄)₂SO₄ in the catholyte and 0.1 M Zn(II), 1M (NH₄)₂SO₄ and 2 M NH₃ in the anolyte. After discharging and charging, the anolyte effluent was regenerated and then operated in next process. Acid was used for fully dissolving the precipitates that were produced in the two regeneration processes of one cycle. “12Ω discharge” and “CCC” represent “constant discharge load of 12Ω ” and “constant current charge”, respectively);

FIG. 15 shows the peak discharge power density and maximum net energy density of the Cu/Zn-TRAB over successive regeneration cycles under different charge and discharge conditions (The initial electrolyte contained 0.1 M Cu(II) and 1 M (NH₄)₂SO₄ in the catholyte,and 0.1 M Zn(II), 1 M (NH₄)₂SO₄ and 2 M NH₃ in the anolyte);

FIGS. 16(a) and (b) show the comparisons of power density and electrode potentials of Ag—Zn and Cu—Zn bimetallic thermally regenerative ammonia-based batteries;

FIG. 17(a) is a schematic structural view of a bimetallic thermally regenerative ammonia-based flow battery (B-TRAFB);

FIG. 17(b) is an exploded view drawing of a bimetallic thermally regenerative ammonia-based flow battery (B-TRAFB);

FIGS. 18(a) and (b) are schematic cross-sectional views of a single Cu/Zn-TRAFB during discharging and charging;

FIGS. 18(c) and (d) are schematic diagrams showing the connection of two Cu/Zn-TRAFBs in parallel and in series during discharging;

FIG. 18(e) is a schematic view showing the construction of each part and details of flow paths in a Cu/Zn-TRAFB during discharging;

FIG. 18(f)is a photograph of the laboratory set-up of the entire Cu/Zn-TRAFB system;

FIGS. 19(a) and (b) show the effects of current density on battery voltages and electrode potentials of a single Cu/Zn-TRAFB during discharging and charging, using 0.1 M CuSO₄ and 1 M (NH₄)₂SO₄ in the catholyte, and 0.1 M ZnSO₄, 1 M (NH₄)₂SO₄ and 2 M NH₄OH in the anolyte recycled with a flow rate of 1 mLmin⁻¹ at discharge tests; 0.1M ZnSO₄ and 1 M(NH₄)₂SO₄ in the catholyte, and 0.1M CuSO₄, 1M (NH₄)₂SO₄ and 2M NH₄OH in the anolyte recycled with a flow rate of 1 mL min⁻¹ at charge tests.

FIG. 20(a) shows the effects of different (NH₄)₂SO₄ concentrations on Cu/Zn-TRAFB power density at a flow rate of 1 mL min^{-l}using 0.1 M CuSO₄in the catholyte, and 0.1 M ZnSO₄ and 2 M NH₄OH in the anolyte;

FIG. 20(b) shows the effects of different CuSO_{4/}ZnSO₄ concentrations on Cu/Zn-TRAFB power density at a flow rate of 1 mL min^{-l}using 1 M (NH₄)₂SO₄ in the catholyte, and 1 M (NH₄)₂SO₄and 2 M NH₄OH in the anolyte;

FIG. 20(c) shows the effects of different NH₄OH concentrations on Cu/Zn-TRAFB power density at a flow rate of 1 mL min^{-l}using 0.4 M CuSO₄ and 1 M (NH₄)₂SO₄in the catholyte, and 0.4 M ZnSO₄ and 1 M (NH₄)₂SO₄ in the anolyte;

FIG. 21 shows the effects of different CuSO_{4/}ZnSO₄ concentrations on Cu/Zn-TRAFB electrode potentials at a flow rate of 1 mL min^{-l}using 1 M (NH₄)₂SO₄ in the catholyte, and 1 M (NH₄)₂SO₄ and 2 M NH₄OH in the anolyte;

FIG. 22 shows the effects of different flow rates on peak power density of a single Cu/Zn-TRAFB using 0.4 M CuSO₄ and 1 M (NH₄)₂SO₄ in the catholyte, and 0.4 M ZnSO₄ and 1 M (NH₄)₂SO₄ in the anolyte;

FIGS. 23(a) and (b) show battery voltage, energy density and power output evolutions of a single Cu/Zn-TRAFB in one closed cycle. Initial electrolytes contained 20 mL of catholyte with 0.4 M CuSO₄ and 1 M (NH₄)₂SO₄, and 20 mL of anolyte with 0.4 M ZnSO₄, 1 M (NH₄)₂SO₄ and 2 M NH₄OH both pumped into the system at a flow rate of 8 mL min⁻¹. After discharging, the anolyte effluent was regenerated and then operated in the charging process. Some waste sulfuric acid was used for fully dissolving the precipitates that were produced in the regeneration processes.“4Ω discharge” stands for the condition where the cell discharged at a constant load of 4Ω. “CCC-50 A m⁻²” stands for the condition where a constant current density of 50 A m⁻²was applied in the charge process;

FIG. 24(a) shows the experimental cyclic voltammograms (scan rate of 10 mV s⁻¹) obtained in the electrolyte with 0.1 M CuSO₄, 1 M (NH₄)₂SO₄ and 2 M NH₄OH at a glassy carbon rotating disk electrode. The highlighted area showed the Cu anode potential range during the Cu/Zn-fRAFB charge process;

FIG. 24(b) shows the experimental cyclic voltammograms with different scan rates obtained in the electrolyte with 0.1 M ZnSO₄, 1 M (NH₄)₂SO₄ and 2 M NH₄OH at a glassy carbon rotating disk electrode. The highlighted area showed the Zn anode potential range during the Cu/Zn-TRAFB discharge process;

FIGS. 25(a) and (b) show the voltage and power output of two Cu/Zn-TRAFB that were connected in series and parallel, compared with a single Cu/Zn-TRAFB operating at a flow rate of 1 mL min⁻¹ with 0.4 M CuSO₄ and 1 M (NH₄)₂SO₄in the catholyte, and 0.4 M ZnSO₄, 1 M (NH₄)₂SO₄ and 2 M NH₄OH in the anolyte;

FIGS. 26(a) and (b) show the battery voltage, power density and electrode potentials of a single Cu/Zn-TRAFB with a constant current of 16 mA for ten discharge-charge cycles (cell was charged and discharged every 15 min). The 20 mL of catholyte [0.1 M CuSO₄ and 1 M (NH₄)₂SO₄] and 20 mL of anolyte [0.1 M ZnSO₄, 1 M (NH₄)₂SO₄ and 2 M NH₄OH] were recycled at a flow rate of 1 mL min⁻¹ during discharging. The 20 mL of catholyte [0.1 M ZnSO₄and 1 M (NH₄)₂SO₄] and 20 mL of anolyte [0.1 M CuSO₄, 1 M (NH₄)₂SO₄ and 2 M NH₄OH] were recycled at a flow rate of 1 mL min⁻¹ during charging.

### DETAILED DESCRIPTION OF THE INVENTION

The invention will be described in detail with reference to the accompanying drawings and specific examples, in which the advantages and features of the invention can be more readily understood by those skilled in the art. Thus, the protection scope of the present invention is defined clearly.

In the description of the present invention, it is to be understood that the terms of “one”, “multiple”, “first”, “second”, etc. just mean the quantity or position relationship based on the drawings. This is for convenience of describing the invention and simplifying the description, instead of indicating or implying that the referred device or element must have a particular number and location, and operate in a particular number and position. Therefore, it is not to be construed as limiting the invention.

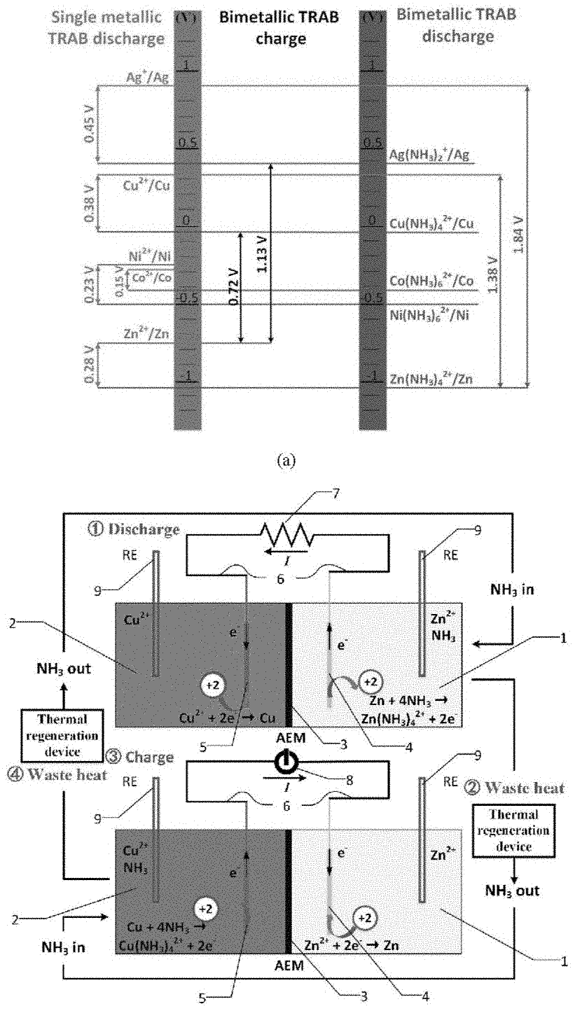

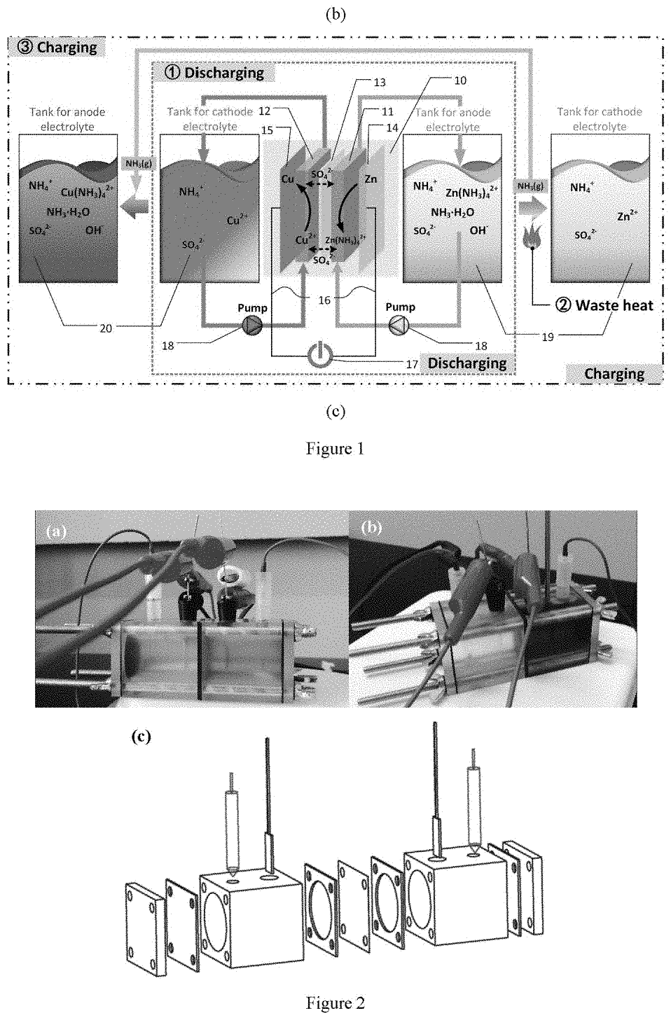

As shown in FIG. 1(b), the bimetallic thermally regenerative ammonia-based battery system is composed of a first electrode chamber 1, a second electrode chamber 2, and a separator 3 interposed between the first electrode chamber 1 and the second electrode chamber 2. The reactor comprises a first electrode 4,a second electrode 5 and reference electrodes 9 placed in the first and second electrode chambers, respectively. The first electrode M₁ and the second electrode M₂ are respectively selected from different metals M, and M is taken from at least one of copper, silver, cobalt, nickel and zinc in a solid form. The electrode potential M₁(NH₃)ₓ₁^{y1+}/M₁ of the first electrode M₁ is smaller than the electrode potential M₂^{y2+}/M₂ of the second electrode M₂, and the larger the difference, the more helps to form a large discharge voltage. The electrode potential of the metal (Ag, Cu, Co, Ni, Zn) coordinated with ammonia M(NH₃)ₓ^{y+}/M is less than the electrode potential of M^{y+}/M, so the charge voltage is less than the discharge voltage. The electrodes are connected by wires 6 to form a loop. The first and second electrode chambers respectively contain an electrolyte composed of an ammonium salt and a salt solution of the respective metals.

The reactor is provided with one or more seals to secure, seal, and prevent air from entering the reactor.

An oxygen-free inert gas is introduced into the electrolyte from a sweep hole to remove oxygen and inhibit electrode corrosion.

The using method of the above-mentioned bimetallic thermally regenerative ammonia-based battery system, comprising the steps of: \textcircled{1}Adding ammonia to the first electrode chamber, thereby the battery discharging: oxidation reaction occurs on the first electrode M₁ in the first electrode chamber: M₁ (s)+x1 NH₃ (aq)→M₁(NH₃)ₓ₁^{y1+}+y1 e⁻; reduction reaction occurs on the second electrode M₂ in the second electrode chamber: M₂^{y2+} (aq)+y2 e⁻→M₂ (s); \textcircled{2}After the end of the discharge, the waste heat is used to separate the NH₃ in the first electrode chamber: M₁(NH₃)ₓ₁^{y1+} [symbol] M₁^{y1+} (aq)+x1 NH₃ (g), and the separated NH₃ is passed into the second electrode chamber, and the cathode and anode chambers are switched; \textcircled{3}Charging:reduction reaction occurs on the first electrode M₁ in the first electrode chamber: M₁^{y1+}(aq)+y1 e⁻→M₁ (s); oxidation reaction occurs on the second electrode M₂ in the second electrode chamber: M₂ (s)+x2 NH₃ (aq)→M₂(NH₃)ₓ₂^{y2+}+y2 e⁻; \textcircled{4}After the end of the charge, the waste heat is used to separate the NH₃ in the second electrode chamber: M₂(NH₃)ₓ₂^{y2+} [symbol] M₂^{y2+} (aq)+x2 NH₃ (g), and the separated NH₃ is passed into the first electrode chamber, and the cathode and anode chambers are switched again to start the second discharge cycle.

A bimetallic thermally regenerative ammonia-based flow battery system, as shown in FIG. 1(c), comprises a cell module 10, two pumps 18 and two electrolyte tanks 19, 20, and a reference electrode 21 is arranged between the pump and the cell module. Each cell module is mainly composed of a first electrode 14, a first electrode chamber 11, a second electrode 15, a second electrode chamber 12, and a separator 13. The electrolytes in the first electrode chamber 11 and the second electrode chamber 12 are continuously flowing, and the electrolytes are stored in the two tanks 19, 20, respectively. The first electrode M₁ and the second electrode M₂ are respectively selected from different metals M, and M is taken from at least one of copper, silver, cobalt, nickel and zinc in a solid form. The electrode potential M₁(NH₃)ₓ₁^{y1+}/M₁ of the first electrode M₁ is smaller than the electrode potential M₂^{y2+}/M₂ of the second electrode M₂, and the larger the difference, the more helps to form a large discharge voltage. The electrode potential of the metal (Ag, Cu, Co, Ni, Zn) coordinated with ammonia M(NH₃)ₓ^{y+}/M is less than the electrode potential of M^{y+}/M, so the charge voltage is less than the discharge voltage. The electrodes are connected by wires 16 to form a loop. The first and second electrode chambers respectively contain an electrolyte composed of an ammonium salt and a salt solution of the respective metals.'The first electrode chamber 11 and the first electrolyte tank 20 are connected,and the second electrode chamber 12 and the second electrolyte tank 19 are also connected. An oxygen-free inert gas is introduced into the first or second electrolyte tanks 19, 20 to remove oxygen and inhibit electrode corrosion.

The cell module is provided with one or more seals to secure, seal, and prevent air from entering the cell module.

An oxygen-free inert gas is introduced into the first and second electrolyte tanks to remove oxygen and inhibit electrode corrosion.

The using method of the above-mentioned bimetallic thermally regenerative ammonia-based flow battery system, comprising the steps of: \textcircled{1}Adding ammonia to the first electrolyte tank, thereby the battery discharging:oxidation reaction occurs on the first electrode M₁ in the first electrode chamber: M₁ (s)+x1 NH₃ (aq)→M₁(NH₃)ₓ₁^{y1+}+y1 e⁻; reduction reaction occurs on the second electrode M₂ in the second electrode chamber: M₂^{y2+} (aq)+y2 e⁻→M₂ (s); \textcircled{2}After the end of the discharge, the waste heat is used to separate the NH₃ in the first electrolyte tank: M₁(NH₃)ₓ₁^{y1+} [symbol] M₁^{y1+} (aq)+x1NH₃ (g), and the separated NH₃ is passed into the second electrolyte tank, and the cathode and anode chambers are switched; \textcircled{3}Charging: reduction reaction occurs on the first electrode M₁ in the first electrode chamber: M₁^{y1+} (aq)+y1 e⁻→M₁ (s); oxidation reaction occurs on the second electrode M₂ in the second electrode chamber: M₂ (s)+x2 NH₃ (aq)→M₂(NH₃)ₓ₂^{y2+}+y2 e⁻; \textcircled{4}After the end of the charge, the waste heat is used to separate the NH₃ in the second electrolyte tank: M₂(NH₃)ₓ₂^{y2+} [symbol] M₂^{y2+} (aq)+x2 NH₃ (g), and the separated NH₃ is passed into the first electrolyte tank, and the cathode and anode chambers are switched again to start the second discharge cycle.

The first electrode M₁ and the second electrode Mein the above-mentioned bimetallic thermally regenerative ammonia-based battery system and flow battery system are composite electrodes and mainly consist of at least two of Ag, Cu, Co, Ni or Zn, or composite carbon electrodes coated with at least one of Ag, Cu, Co, Ni or Zn.

When the first electrode M₁ or the second electrode M₂ is Cu, Co, Ni or Zn, the electrolyte in their respective electrode chamber is ammonium sulfate ((NH₄)₂SO₄) and the corresponding metal sulfate (MSO₄) or ammonium nitrate (NH₄NO₃) and the corresponding metal nitrate (M(NO₃)₂) or a mixture of ammonium sulfate ((NH₄)₂SO₄), ammonium nitrate (NH₄NO₃) and the corresponding metal sulfate (MSO₄) and nitrate (M(NO₃)₂).When the first electrode M₁ or the second electrode M₂ is Ag; the electrolyte is ammonium nitrate (NH₄NO₃) and silver nitrate (AgNO₃). The first electrode or the second electrode may also be aflow electrode.

### EXAMPLE 1

As shown in FIG. 1(a), the single metallic thermally regenerative ammonia-based battery (TRAB) only includes a discharge process and a thermal regeneration process, but its discharge voltage is relatively low. When the silver Ag is used as the electrode, the voltage is only 0.45 V. Although the bimetallic thermally regenerative ammonia-based battery (B-TRAB) needs to be charged, there are two thermal regeneration processes that can recover more waste heat energy, and the charge voltage is much smaller that the discharge voltage. The discharge voltage of Ag/Zn-TRAB can reach 1.84V, and the charge voltage is only 1.13V; the discharge voltage of Cu/Zn-TRAB can reach 1.38V, and the charge voltage is only 0.72V. Similarly, Ag/Ni-TRAB, Ag/Co-TRAB, Ag/Cu-TRAB, Cu/Ni-TRAB, Cu/Co-TRAB, etc. are also in the category of bimetallic thermally regenerative ammonia-based batteries (B-TRABs).

Cu/Zn-TRAB Development and Operation

A single Cu/Zn-TRAB was developed using positive and negative electrode chambers 1, 2 (polycarbonate, 4 cm long and 3 cm in diameter) divided by an anion exchange membrane 3 (AEM, Selemion AMV, 4 cm×4 cm) (See FIG. 1(b) and FIG. 2). Copper positive electrode 5 (50×50 mesh, McMaster-Carr; 0.8 cm×2 cm, weight of 0.2160±0.0005 g) and zinc negative electrode 4 (0.2 mm thick sheet, McMaster-Carr; 0.8 cm×2 cm, weight of 0.2400±0.0005 g) were inserted into the chambers and connected by copper or zinc wires 6 to an external resistance (discharge) 7 or power source (charge) 8. Two Ag/AgCl reference electrodes 9 (+208.2 mV versus SHE at 20° C., R0303, aida, 2 cm away from the electrode) were put into the electrolytes for monitoring the electrode potentials. An egg-shaped stir bar (6.4×15.9 mm, VWR, 500 rpm) was only used in the cathode chamber for fully mixing the catholyte.

In the experiments, different concentrations of CuSO₄/ZnSO₄ (Alfa Aesar; 0.05 M˜0.3 M), (NH₄)₂SO₄ (Alfa Aesar; 0 M˜2 M) and ammonium hydroxide (Aladdin, AR, 25˜28% ; 1 M˜3 M) were prepared for the electrolytes using ultrapure water. The electrolyte conductivity and pH were measured by a multi-parameter tester (S470, METTLER TOLEDO). For the purpose of investigating the performance of Cu/Zn-TRAB comprehensively over multiple cycles, the battery was operated at constant discharging and charging current densities (100 and 200 A m⁻²) in a cycle, or was discharged at a constant load of 12Ω (external resistance) and charged at a constant current density of 100 A m⁻², with the discharging cycle terminated when the voltage was <0.6 V and the charging cycle terminated when the charge capacity was equal to discharge capacity. After the charge and discharge, the electrolytes were collected separately, and the anolyte was heated at a constant temperature of 50° C. for distilling NH₃ out and regenerating to new catholyte for next process. This distilled NH₃ (in the form of NH₃.H₂O) was put into the collected catholyte to generate new anolyte for the next process. All experiments were conducted at room temperature (20˜30° C.).

Measurements and Calculations

Polarization tests were performed using a battery testing equipment (Arbin Instruments, BT-G) connected to a personal computer. In the discharge tests, current (I, A) scanning with a rate of 1 mA s⁻¹ started from open circuit (0 A) to zero voltage. While current scan stopped when the voltage reached 1.8 V at the charge tests. Battery voltage (U, V) and electrode potentials relative to respective Ag/AgCl reference electrode were recorded at each time interval. Current density was calculated and normalized to an electrode projected area of 1.6×10⁴ m². Area-averaged power density (Pₐ, W m⁻²) was calculated using the electrode projected area (1.6×10⁻⁴ m², P-electrode) for comparing with the previous single metallic TRABs and using the membrane projected area (7×10⁻⁴ m², Pₘ) for contrasting with other technologies. Before the tests, the quiet time was set as 30 seconds, and the open circuit potential was recorded every 10 seconds.

In the successive regeneration cycle experiments, the amount of charge accumulated during discharging or charging was obtained as Q=∫ I dt, and discharge or charge energy was computed using the formula of W=∫UI dt. The volume-normalized net energy density was obtained through dividing the produced net energy in one cycle (W_{d}−W_{c}) by the total electrolyte volume of 56 mL. The cathode and anode coulombic efficiencies (CCE and ACE) were calculated as the ratio between actual accumulated charge and theoretical amount of charge in terms of the electrode mass change, as follows:

During the discharge:

$${CCE}_{d} = \frac{( {m}_{f , Cu} - {m}_{0 , Cu} ) nF}{{Q}_{d} {M}_{Cu}} \times 100 A C {E}_{d} = \frac{{Q}_{d} {M}_{Zn}}{( {m}_{0 , Zn} - {m}_{f , Zn} ) nF} \times 100$$

During the charge:

$${CCE}_{c} = \frac{( {m}_{f , Zn} - {m}_{0 , Zn} ) nF}{{Q}_{c} {M}_{Zn}} \times 100 A C {E}_{c} = \frac{{Q}_{c} {M}_{Cu}}{( {m}_{0 , Cu} - {m}_{f , Cu} ) nF} \times 100$$

where m₀ and m_{f} denote the electrode masses before and after the discharge or charge tests and are measured by an analytical balance, F (96485 C mol⁻¹) is the Faraday constant, n (n=2 for Cu and Zn) is the number of electron involved in the electrode reaction, Q_{d} and Q_{c} are the total charge transferred and subscripts d and c represent the discharge and charge processes, respectively, and M_{Cu} and M_{zn} are the molecular weight of the metals (Cu, 63.55 g mol⁻¹; Zn, 65.38 g mol⁻¹).

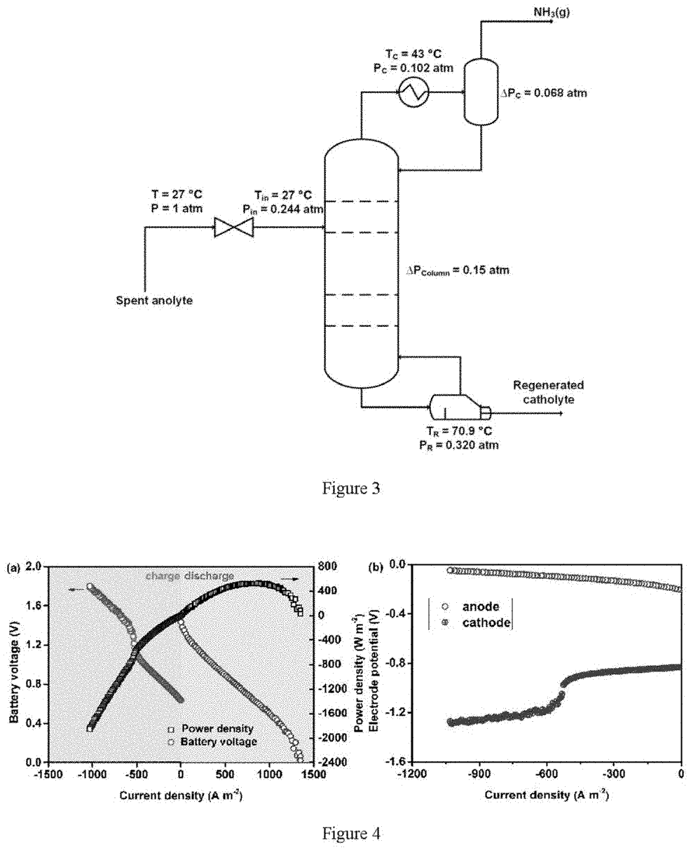

The B-TRAB system needs four steps to complete the thermoelectric conversion. At first, the battery discharges with higher voltage. And then waste heat is used to regenerate the spent anolyte and shift the redox couples to a lower potential for charging. The battery is charged at lower voltage and net energy is produced, and then waste heat is used to regenerate the anolyte again and shift the redox couples to a higher potential for next discharging cycle. Therefore, the thermal-electricity conversion efficiency is determined as the ratio between the net energy and the demanded thermal energy for two regeneration processes (ηₜ=net energy/demanded thermal energy). Usually, the energy conversion efficiency relative to the Carnot efficiency (η_{C}32 1−T_{L}/T_{H}) [η_{t/C}=net energy/(required thermal energy×(1−T_{L}/T_{H}))] was reported for comparing with other techniques, in which T_{L} is the inlet temperature Tᵢₙ and T_{H} is the reboiler temperature T_{R}. Ignoring the separation energy of copper and zinc ammine complexes, the column thermal energy required for NH₃ distillation from the anolyte was estimated by establishing a simplified model (that treated the anolyte as a mixture of NH₃ and H₂O ) with Aspen HYSYS (See FIG. 3). In this model, the reboiler temperature was set at 70.9° C., and the inlet pressure of the electrolyte is 0.244 atm. Different inlet temperatures (27 and 40° C.) and condenser temperatures (43 and 25° C.) were used to analyze the factors of thermal energy efficiency. Because only the anolyte needed to be thermally regenerated, this thermal energy consumed in column was based on the anolyte volume of 28 mL.

Scanning electron microscope (SEM) was used to analyze the zinc electrode after 30 min of the constant-current charge tests, confirming that the zinc was deposited and the morphology was related to current density. Besides, the SEM images and corresponding EDS (Energy dispersive spectrum) were used to analyze the reasons for the low anodic coulombic efficiency of copper and zinc electrodes. X-ray diffraction (XRD) was performed for exploring the composition and structure of the precipitates produced during the thermal regeneration processes.

Results

Charge and Discharge Characteristics

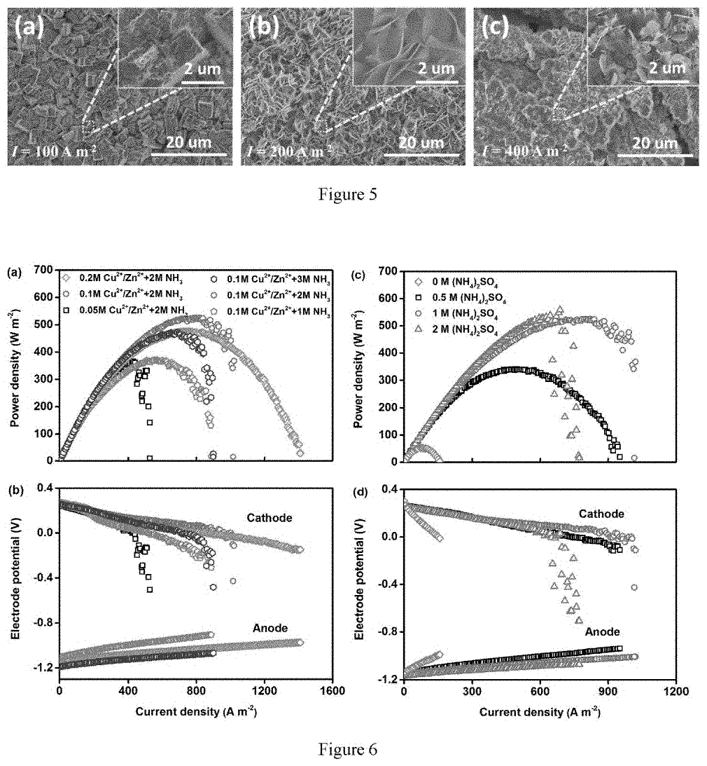

The charge and discharge characteristics of the Cu/Zn-TRAB were examined using fresh electrolytes instead of the regenerated electrolytes in this section. During the discharge, there was a peak power density (FIG. 4). In the charging process, because the reduction potential of the hydrogen evolution reaction (2H⁺+2e⁻→H₂, E⁰=0 V) is more positive than the potential of the cathode reaction (Zn²⁺+2e⁻→Zn, E⁰=−0.76 V), theoretically, the hydrogen evolution reaction occurs preferentially in acidic solution. However, the actual overpotential of the hydrogen reduction is very high at the Zn electrode, so the deposition efficiency of Zn²⁺ in weakly acidic solutions is nearly 100% . The Cu/Zn-TRAB was charged at different current densities for 30 min, and the current efficiency was higher than 90% (94% , 100 A m⁻²; 97% , 200 A m⁻²; 98% , 400 A m⁻²). Larger current densities was more conducive to higher current efficiency, but the SEM images of the zinc electrode showed that more and larger crystalline dendrites were generated during the zinc deposition at large currents (See FIG. 5). The charging voltage was less than the discharging voltage when the current density was lower than 400 A m⁻², and then the charging voltage increased rapidly with increasing current densities (FIG. 4(a)). This increase was mainly due to the fact that the cathode potential shifted negatively with growing current densities (FIG. 4(b)), indicating that some side reactions (Zn(OH)₂+2e⁻→Zn+2OH⁻ or Zn(NH₃)₄²⁺+2e⁻→Zn+4NH₃, E⁰=−1.25 V) may be appear as a result of increased pH near the Zn electrode. These results manifested that the metal zinc could be used as the negative electrode of B-TRAB for high battery voltage and power productions, and high-voltage discharge and low-voltage charge can be achieved when a smaller charge current is applied.

Power Production at Different NH₃ and Cu(H)/Zn(H) Concentrations During Discharge

Power density is significant for thermoelectric conversion, because high power density (or large current outputs) means that the transfer and storage of the produced electrical energy are more efficient and convenient. Consequently, the performance of the Cu/Zn-TRAB was inspected with various NH₃ and Cu(II)/Zn(II) concentrations in a 1 M (NH₄)₂SO₄ supporting electrolyte. As shown in FIG. 6(a), when the anodic NH₃ concentration increased from 1 M to 2 M (the actual concentration of ammonia is greater than this value (concentration of ammonium hydroxide)), the maximum power density was improved from 370 W m⁻²-electrode (85 W m⁻²-membrane) to 525 W m⁻²-electrode (120 W m⁻²-membrane), primarily owing to both the promotion of anode performance and the reduction of cathode overpotentials (FIG. 6(b)). The more negative anode potentials at increased NH₃ concentrations were due to the enhanced anode performance. However, a further increase to 3 M led to a decrease of maximum power density to 472 W m⁻²-electrode (108 W m⁻²-membrane), and the main reason was that the reduction of cathode overpotentials was weakened. The increased pH of the anolyte (from 10.3 to 10.6) may explain this. The OH⁻ionized by the NH₃.H₂O and NH₃ molecules will permeate through the AEM and react with the Cu²⁺ in the catholyte, resulting in a decrease in the cathode potentials.

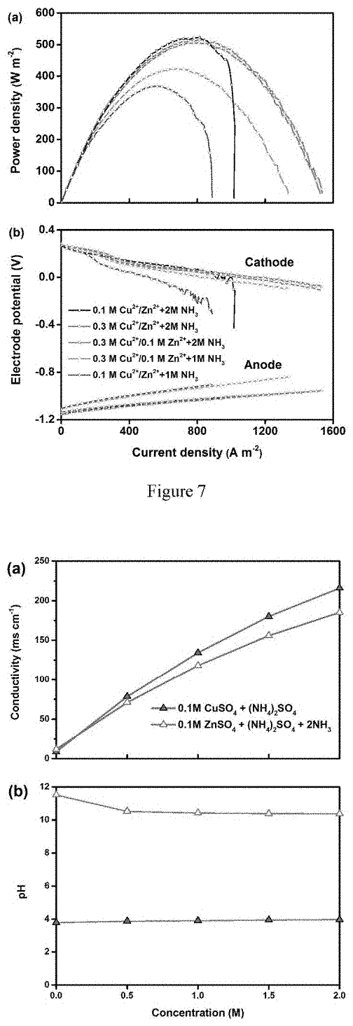

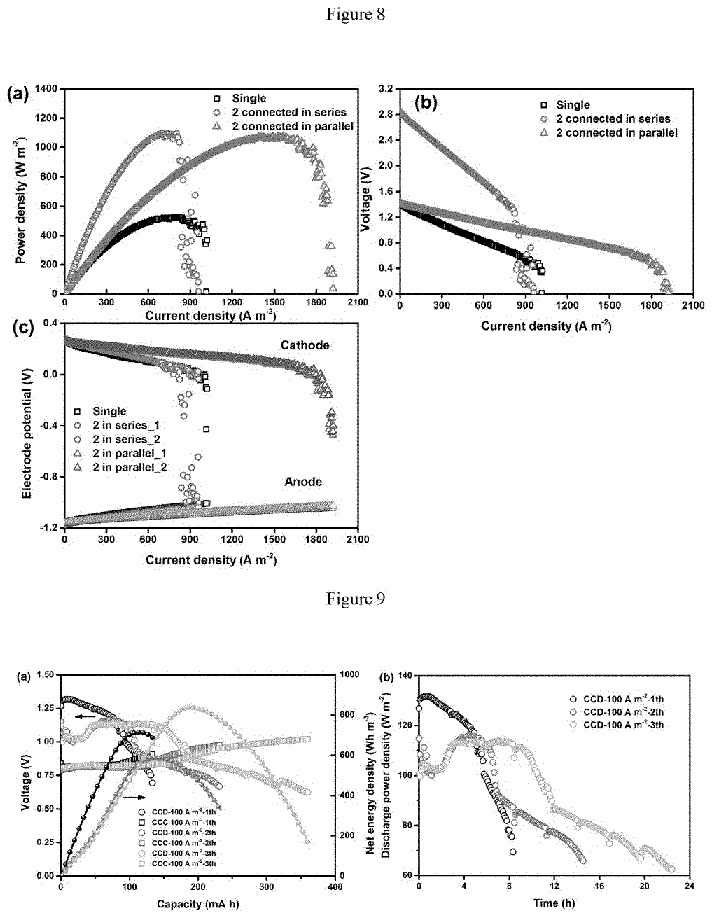

The highest power density of 525 W m⁻²-electrode (120 W m⁻²-membrane) was generated with 2 M NH₃ when the Cu(II)/Zn(II) concentrations were 0.1 M (FIG. 6(a)). When the Cu(II)/Zn(II) concentrations were reduced to 0.05 M, the maximum power density sharply decreased to 365 W m⁻²-electrode (83 W m⁻²-membrane), mainly resulting from the more negative cathode potentials with decreasing Cu(II) concentrations. A slightly decreased power density of 478 W m⁻²-electrode (109 W m⁻²-membrane) was achieved by increasing the Cu(II)/Zn(II) concentration to 0.2 M, which deteriorated the cathode performance but the anode potentials were not evidently affected (FIG. 6). Moreover, appropriately reducing the initial Zn(II) (namely Zn(NH₃)₄²⁺) concentration could slightly improve the power densities and a higher NH₃ concentration was beneficial to use higher Cu(II) concentrations (See FIG. 7).

Power Production with a Range of Concentrations of the Supporting Electrolyte During Discharge

Increasing the (NH₄)₂SO₄ concentration from 0 to 2 M commonly promoted the maximum power density (53 W m⁻²-electrode, 0 M; 340 W m⁻²-electrode, 0.5 M; 525 W m⁻²-electrode, 1 M; 558 W m⁻²-electrode, 2 M) (FIG. 6(c)), due to the increase of electrolyte conductivities (See FIG. 8). Nevertheless, power production was more unstable at higher (NH₄)₂SO₄ concentrations, especially in the 2 M tests. To minimize this concentration polarization, the catholyte was stirred for achieving high power densities during all the tests. Moreover, the power production was not observably enhanced when the (NH₄)₂SO₄ concentration increased from 1 to 2 M. Increasing the concentration of (NH₄)₂SO₄ had more appreciable influence on the anode potentials than the cathode potentials, because the concentrated NH₄⁺ retrained the dissociation of ammonia and improved the activities of ammonia, resulting in more negative anode potentials (FIG. 6(d)).

Battery Scalability

In order to evaluate the scalability of the Cu/Zn-TRAB system, power density, voltage and electrode potentials were examined using two Cu/Zn-TRABs connected in series and parallel. The maximum discharging power density reached 1090 W m⁻²-electrode (249 W m⁻²-membrane) with two cells in series or parallel, and this value was about twice as much as that obtained by a single cell (525 W m⁻²-electrode (120 W m⁻²-membrane)) (FIG. 9). The battery voltage was increased from 1.42 to 2.85 V with two series operation, while the maximum current density was increased from 1016 to 1921 A m⁻² with two parallel operation (FIG. 9(b)). The electrode performance with the two cells in series configuration was similar to that obtained by a single cell, and the cathode potential of the second cell (near the positive electrode side of the whole battery) was first attenuated at larger current densities. The electrode performance with the two cells in parallel configuration was better than that of a single cell, and the electrode potentials of the two single cells were identical (FIG. 9(c)). Therefore, the Cu/Zn-TRAB system can be scale up for boosting the whole battery voltage, current and power production.

Cycling Performance and Thermal Efficiency

The stability of the battery performance over multiple successive cycles is significant for efficiently converting the low-grade thermal energy into electricity. Thus, power and net energy productions by the Cu/Zn-TRAB were investigated using regenerated electrolytes over three successive cycles [0.1 M Cu(II) and 1 M (NH₄)₂SO₄ in the catholyte and 0.1 M Zn(II), 1 M (NH₄)₂SO₄ and 2 M NH₃ in the anolyte before the first discharge cycle]. The power and energy densities can't be promoted at the same time, so the cell performance was analyzed under different conditions.

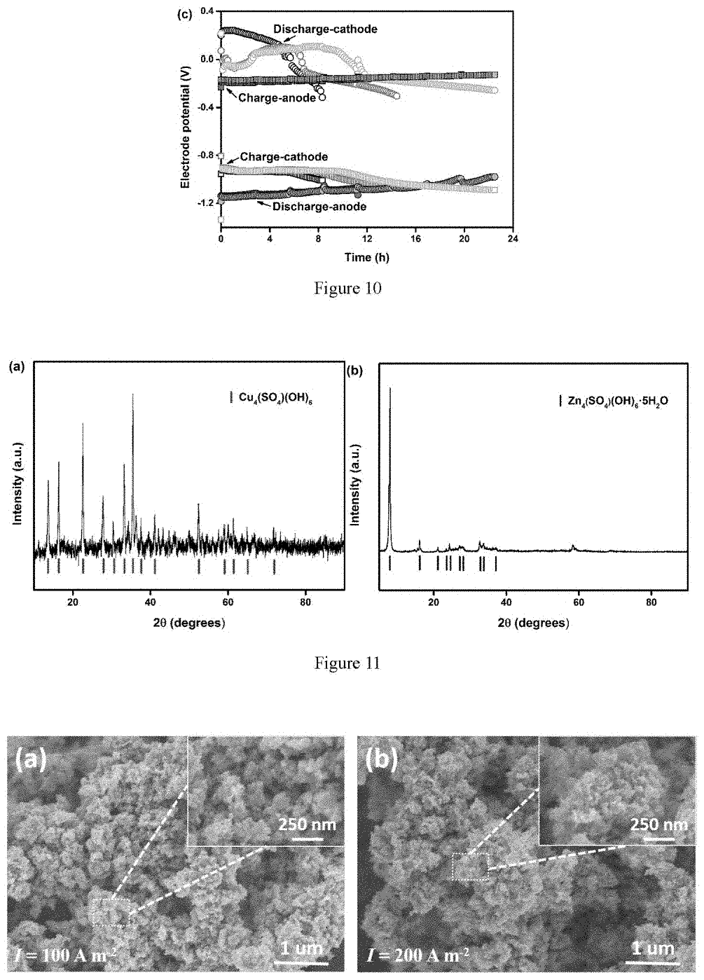

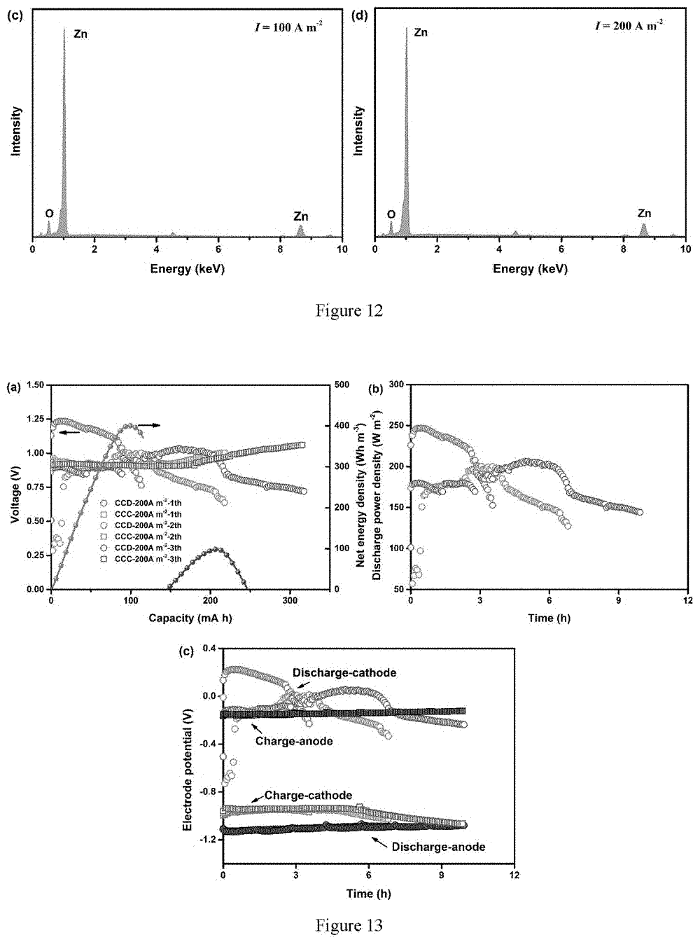

The first is the case where a small constant current density of 100 A m⁻² is applied, as shown in FIG. 10.In the first discharge cycle, the voltage and cathode potential dramatically decreased at the end of the cycle with initial fresh electrolytes, since the depleted Cu²⁺ affected the deposition reaction. The peak discharging power density and maximum net energy density in this initial cycle were 132 W m⁻²-electrode (30 W m⁻²-membrane) and 714 W h m⁻³, respectively (FIG. 15). The coulombic efficiency of the cathode (based on the mass change of the copper cathode) during discharge was 85±5% , and an anodic coulombic efficiency of 70±5% was obtained. After the discharge, the anolyte effluent was heated for evaporating ammonia (simulating distillation), and the catholyte effluent was added to concentrated ammonia for charging cycle. The pH of the anolyte effluent decreased from ˜10.3 to ˜7.1 after thermal regeneration, during which there was precipitate formation in the solution as a result of the hydrolysis of the Zn(NH₃)₄²⁺. X-ray diffraction (XRD) analysis showed that this precipitate was mainly basic zinc sulfate Zn₄(SO₄)(OH)₆.5H₂O (See FIG. 11). The charging voltage with the regenerated electrolytes was ˜0.82 V. In charging cycle, the coulombic efficiency of the zinc cathode was 107±5% , indicating that almost no side reactions occurred expected for Zn²⁺ reduction. The coulombic efficiency of the copper anode was 49±5% and no passivation film was observed on the surface of the copper mesh, making the copper more susceptible to be corroded compared to zinc. The black passive film formed on the zinc, surface that inhibited the oxidation of the zinc electrode. The SEM images and corresponding EDS analysis confirmed that the black film mainly consisted of nano-scale zinc and a small amount of zinc oxide particles (See FIG. 12).Dissolved oxygen in the solution may accelerate the corrosion process, as the reaction [Cu (s)+1/2O₂+4NH₃.H₂O→Cu(NH₃)₄²⁺+2OH⁻+3H₂O], resulting in the anode efficiency of less than 100% .In the second and third closed-loop cycles, ammonia was separated from the Cu(NH₃)₄²⁺ anolyte after charging and the spent catholyte was added to concentrated ammonia for the next discharge cycle. The pH of the anolyte effluent dropped from ˜10.4 to ˜6.4. Similarly, a precipitate during this process formed due to the hydrolysis of the Cu(NH₃)₄²⁺, and the XRD tests showed that this precipitate was mainly basic copper sulfate Cu₄(SO₄)(OH)₆ (See FIG. 11). For the two successively regenerative cycles, due to the existence of this precipitate for more negative electrode potential of Cu₄(SO₄)(OH)₆/Cu, the peak discharging power density was reduced but relatively steady, averaging 115 W m⁻²-electrode (26 W m⁻²-membrane) [132 W m⁻²-electrode (30 W m⁻²-membrane), cycle 1; 116 W m⁻²-electrode (27 W m⁻²-membrane), cycle 2; 114 W m⁻²-electrode (26 W m⁻²-membrane), cycle 3] (FIG. 15). The mixing of two reduction reactions (Cu₄(SO₄)(OH)₆+8e⁻→4Cu (s)+6OH⁻+SO₄²⁻ and Cu²⁺+2e⁻→Cu (s)) was the reason for the lower discharging power density using regenerated electrolytes. The maximum net energy density was also weakened in the second cycle (714 W h m⁻³, cycle 1; 589 W h m⁻³, cycle 2; 838 W h m⁻³, cycle 3) (FIG. 15). The improvement of net energy density in the third cycle was due to the accumulation of charge or capacity in the previous cycles, which was consistent with higher Cu(II) and Zn(II) concentrations in the regenerated catholyte on the account of lower coulombic efficiencies of the copper and zinc anodes. This excess electrode corrosion could be relieved by removing the O₂ dissolved in the electrolyte, and recovered by some electrodeposition technologies. Peak discharging power densities were comparatively stable in the two continuously regenerated cycles, demonstrating well repeatability over successive cycles.

For a large current density of 200 A m⁻², the peak discharging power densities [246 W m⁻²-electrode (56 W m⁻²-membrane), cycle 1; 202 W m⁻²-electrode (46 W m⁻²-membrane), cycle 2; 205 W m⁻²-electrode (47 W m⁻²-membrane), cycle 3] were improved with an averaged value of 204 W m⁻²-electrode (47 W m⁻²-membrane) in the two successive regeneration cycles, but the maximum net energy density (400 W h m⁻³) in the initial cycle was greatly reduced (see FIG. 15). More seriously, the maximum net energy density in the second and third successive cycles dropped below 100 W h m⁻³, mainly due to more negative cathode potentials in the discharge, indicating that the reduction potentials of Cu₄(SO₄)(OH)₆/Cu was more negative at large current densities (See FIG. 13).

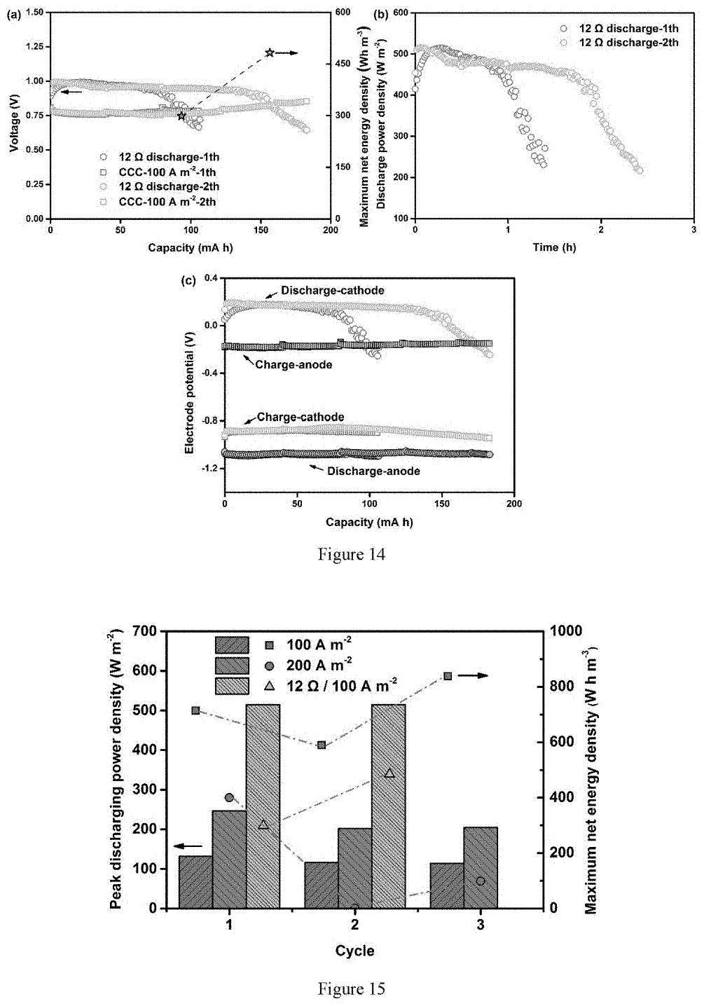

In order to achieve the maximum power density and a higher net energy density, cells were discharged at a constant load of 12 Ω (external resistance) and charged at a lower constant current density of 100 A m⁻², with the discharging cycle terminated when the voltage was <0.6 V and the charging cycle terminated when the charge capacity reached discharge capacity (See FIG. 14). Simultaneously, some waste sulphuric acid was used to dissolve the Zn₄(SO₄)(OH)₆.5H₂O and Cu₄(SO₄)(OH)₆ precipitates in the regenerated catholytes. The results showed that the maximum power densities [515 W m⁻²-electrode (118 W m⁻²-membrane), cycle 1; 515 W m⁻²-electrode (118 W m⁻²-membrane), cycle 2] were achieved and maintained in the successive cycles, and the maximum net energy density (299 W h m⁻³, cycle 1; 484 W h m⁻³, cycle 2) did not decrease in the second cycle (FIG. 15). These results indicated that inexpensive acid could be used for achieving and maintaining a better battery performance.

Based on a distillation model developed by the software of Aspen HYSYS, the thermal energy demanded for NH₃ separation from the anolyte (2 M) in one cycle was estimated to be 372 kW h m⁻³-anolyte (See FIG. 3), with a condenser temperature (T_{C}) of 43° C., a reboiler temperature (T_{R}) of 70.9° C., an inlet temperature (Tᵢₙ) of 27° C., and an inlet pressure of 0.244 atm for a single distillation column. With a net energy density of 838 W h m⁻³ obtained at a current density of 100 A m⁻², the thermal energy efficiency was 0.45% (3.5% relative to the Carnot efficiency). An increase of the inlet temperature from 27 to 40° C. slightly improved the thermal energy efficiency (from 0.45% to 0.51% ) because the heat duty for distillation decreased from 372 to 327 kW h m⁻³-anolyte, while that relative to the Carnot efficiency (from 3.5% to 5.7% ) had a relatively appreciable improvement due to the, obvious decrease of the Carnot efficiency from 13% to 9% . However, with an inlet temperature of 40° C., a lower condenser temperature could significantly promote the thermal energy efficiency (from 0.43% to 0.95% ) and that relative to the Carnot efficiency (from 5.7% to 10.7% ) owing to the reduction of heat duty (from 327 kW h m⁻³-anolyte (43° C.) to 88 kW h m⁻³-anolyte (25° C.)).

### EXAMPLE 2

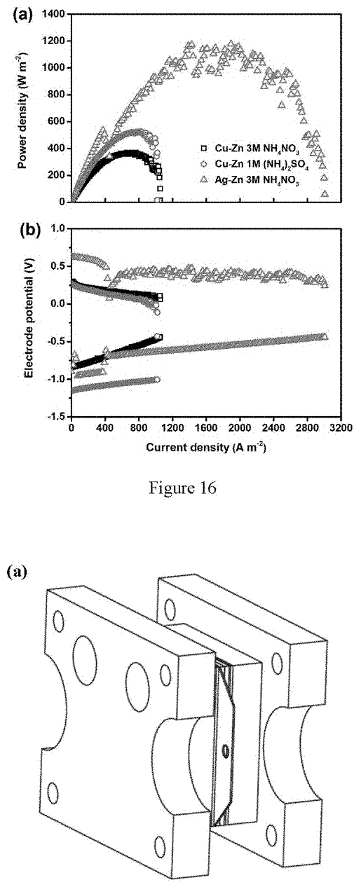

The theoretical discharge voltage of Ag/Zn-TRAB can reach 1.84 V, and the charge voltage is only 1.13 V. The silver electrode (0.2 mm thick sheet,0.8 cm×2 cm) was used instead of the copper mesh electrode, and the battery was tested with 0.1 M Ag(I) and 3 M NH₄NO₃ in the catholyte and 0.1 M Zn(II), 3 M NH₄NO₃ and 2 M NH₃ in the anolyte. As shown in FIG. 16(a), the maximum power density of Ag/Zn-TRAB is about 1175 W m⁻², which is more than twice that of Cu/Zn-TRAB under the same concentration, and there is a possibility of further optimization. From the FIG. 16(b), the anode potential of Ag/Zn-TRAB is lower than that of Cu/Zn-TRAB, which may be due to the influence of anions (NO₃⁻, SO₄²⁻). The passivation film ZnO/Zn(OH)₂ is formed on the surface of Zn during the anode process, which lowers the pH near the surface of the electrode, thereby reducing the concentration of NH₃in the electrode surface. Different anions have a decisive effect on the difficulty of breaking the passivation film. SO₄²⁻ is good for breaking, and NO₃⁻ is not favorable. Therefore, the anode potential in the presence of NO₃⁻ is less than that of SO₄²⁻, which means that it is more different to be oxidized.

### EXAMPLE 3

Compared to previous liquid-based technologies, B-TRABs increase the power density to a much higher level and have good efficiency and energy output performance. However, the previous B-TRAB system (see FIG. 2(c)) had some shortcomings that would greatly limit the battery performance, such as: I) the design of battery device was not convenient for continuous cycle operation, leading to intermittent power production; II) the distance between the electrodes (20-25 mm) was large, which increased the battery internal resistance; III) a small ratio (0.23 m² m⁻²) of the electrode area to the membrane area lowered the availability of the membrane and increased the costs, and the membrane-normalized performance was also deteriorated; IV) a small ratio (5.7 m² m⁻³) of the electrode area to the electrode chamber volume weakened the volume-averaged performance. To avoid these shortcomings, a bimetallic thermally-regenerative ammonia-based flow battery (B-TRAFB) was presented here, and it worked similarly to previous B-TRABs (see FIG. 1(c)). The main difference was that in this flow battery system, the electrolytes were stored in external reservoirs and continuously circulated through the battery by peristaltic pumps. The discharging and charging energy were determined by the electrolyte volume in the reservoirs, and the switching of the discharge and charge cycles only needed to replace the reservoirs. Moreover, the electrodes, flow channels, and membranes were stacked together; and this compact design allowed for a significant reduction of occupied space. The distance of two electrodes was narrowed to 3 mm, which helped to reduce the cell internal resistance. The ratios of the electrode area to the membrane area (1 m² m⁻²) and the electrode chamber volume (667 m² m⁻³) were greatly increased, improving the use efficiency of membrane, power and energy densities, and reducing the system costs. The flow battery system also could be applied to other B-TRAFB systems using different metals (Ag, Cu, Co, Ni and Zn) as the electrode plates.

Cu/Zn-TRAFB System Configuration and Operation

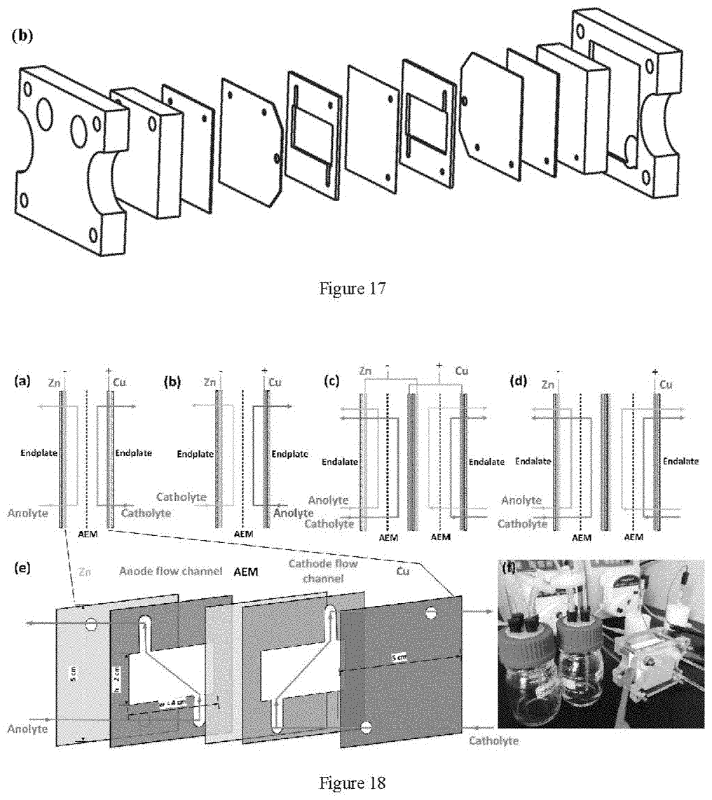

The construction of a single Cu/Zn-TRAFB(shown in FIG. 17) was carried out by stacking a copper positive electrode (5×5×0.05 cm, McMaster-Carr), a zinc negative electrode (5×5×0.05 cm, McMaster-Carr), two flow channel (2×4×0.15 cm, High-Purity High-Temperature Silicone Rubber sheets, McMaster-Carr), and an anion exchange membrane (AEM, 5×5 cm, Selemion AMV). The two electrodes were respectively connected to the PTFE fixed blocks by an adhesive-back silicone rubber sheet, and then integrally embedded in two polycarbonate endplates with a groove (5×5×0.2 cm), and then fixed by bolts and nuts. The series and parallel connections of multiple cells only needed to increase the number of electrodes, flow channels and membranes and other fixing parts were unchanged, and two adjacent electrodes were separated by an insulating silicone gasket (FIGS. 18(c) and (d)). Except for the battery module, the flow battery system also included catholyte and anolyte reservoirs, two peristaltic pumps, two reference cells and PTFE tubes (FIGS. 18(f) and 1(c)). The position of the reference cell was between the pump and the battery inlet, and two reference electrodes (+204 mV versus SHE at 20° C., R0305, Tianjin aida) were inserted into the reference cells to detect the electrode potentials. The PTFE tubes were connected to the internal thread on the PTFE fixed blocks by the external thread joints, and the electrolytes flowed into and out of the battery from the joints.

The electrolytes with different concentrations of (NH₄)₂SO₄ (0.5 M˜2 M, Alfa Aesar), CuSO₄/ZnSO₄ (0.1 M˜0.5 M, Alfa Aesar) and ammonium hydroxide (1 M˜3 M, Aladdin, 25˜28% AR) were prepared using ultrapure water and pumped into the battery system at different flow rates. All experiments were conducted at room temperature (20˜30° C.).

Measurements and Calculations

Battery performance tests were carried out by a computer-controlled battery tester (BT-G, Arbin Instruments). In the polarization tests, 20 mL of different concentrations of electrolytes were circulated in the system at different flow rates. During the discharge process, the current (I, A) was scanned from open circuit to zero voltage at a rate of 1 mA s⁻¹, and the scan was turned off when battery voltage reached 1.5 V in the charge process. Battery voltage (U, V) and electrode potentials relative to the reference electrodes were measured and recorded. The electrode potentials reported in this work were converted to the potentials relative to the SHE. Power (P, W) was obtained by multiplying the current and voltage as P=UI. Based on the projected membrane area (8×10⁴ m²), the area-averaged current (Iₐ, A m⁻²) and power (Pₐ, W m⁻²) densities were received, and the volume-averaged power density (Pᵥ, W m⁻³) could be calculated by using the total reactor volume (2.4×10⁻⁶ m³).

In the net energy density test, constant load (4Ω) discharge was performed firstly with optimized electrolytes (20 mL of catholyte with 0.4 M CuSO₄ and 1 M (NH₄)₂SO₄, and 20 mL of anolyte with 0.4 M ZnSO₄, 1 M (NH₄)₂SO₄ and 2 M NH₄OH) and flow rate (8 mL min⁻¹), and it was cut off when the voltage was lowered to 0.6 V. The accumulated charge Q_{d} and output energy E_{d} during the discharge process were also recorded. After the end of the discharge, the spent anolyte was collected for thermal regeneration. In the initial experiment, a method of constant temperature heating (50° C.) on a magnetic stirrer was used to remove NH₃, forming a regenerated catholyte for the next charge cycle. The evaporated NH₃ was not collected in the current experiment, and concentrated ammonia was added into the catholyte to form a new anolyte for charging. The regenerated catholyte produced a basic precipitate during thermal regeneration, and adding some waste sulphuric acid could dissolve this precipitate. But because of the low solubility of (NH₄)₂Zn(SO₄)₂, it still existed as a precipitate, so the catholyte was magnetically agitated with an egg-shaped stir bar (6.4×15.9 mm, VWR, 600 rpm) in the charge process. Constant current (50 A m⁻²) charge was performed with the regenerated electrolytes, and the charging cycle was turned off when the charge capacity was equal to the discharge capacity. The accumulated charge Q_{c} and input energy E_{c} in the charge process were also recorded. The difference between the output energy and the input energy was the net energy (Eₙ=E_{d}−E_{c}) in one cycle, and the volume-averaged net energy density (E_{n,v}, Wh m⁻³) was calculated based on the anolyte volume (20 mL).Theanode and cathode coulombic efficiencies could be obtained using the mass changes of electrodes and the actual accumulated charges (Q_{d} and Q_{c}).

Since a closed cycle of the Cu/Zn-TRAFB included a discharge process, a charge process and two thermal regeneration processes, the thermoelectric conversion efficiency (ηₜ) was calculated by the ratio of the net energy density in one cycle and the thermal energy required for the two thermal regeneration processes. The net energy density was obtained experimentally and the required thermal energy was estimated from a distillation model developed using Aspen HYSYS. Based on a traditional simulation condition with an inlet temperature of 27° C., a reboiler temperature of 70.9° C. and a condenser temperature of 43°, the thermal energy needed to separate 2M NH₃ from the anolyte twice in one cycle was about 372 kW h m_{anolyte}⁻³. In order to make a fair comparison with other heat-to-electricity technologies, the Carnot-relative efficiency (η_{t/C}=ηₜ/η_{C}) was also reported, and the Carnot efficiency (η_{C}=1−T_{L}/T_{H}) was calculated using the the inlet temperature T_{L} and the reboiler temperature T_{H}. In addition, the effects of different inlet temperatures and condenser temperatures on energy conversion efficiency were also analyzed.

In the system stability and electrode reversibility tests, a single Cu/Zn-TRAB was discharged and charged every 15 min with a constant current of 16 mA, and a 5-min interval between the discharge and charge cycles was used to drain the electrolytes in the system and exchange the flow paths of the catholyte and anolyte. The same fresh electrolytes were used for each cycle (20 mL of catholyte with 0.1 M CuSO₄ and 1 M (NH₄)₂SO₄, and 20 mL of anolyte with 0.1 M ZnSO₄, 1 M (NH₄)₂SO₄ and 2 M NH₄OH were recycled at a flow rate of 1 mL min^{-l}in the discharge cycle; 20 mL of catholyte with 0.1 M ZnSO₄ and 1 M (NH₄)₂SO₄, and 20 mL of anolyte with 0.1 M CuSO₄, 1 M (NH₄)₂SO₄ and 2 M NH₄OH were recycled at a flow rate of 1 mL min⁻¹ in the charge cycle). Battery voltage, power density and electrode potentials over time were recorded during the tests.

Results

Working Characteristics of Cu/Zn-TRAFB

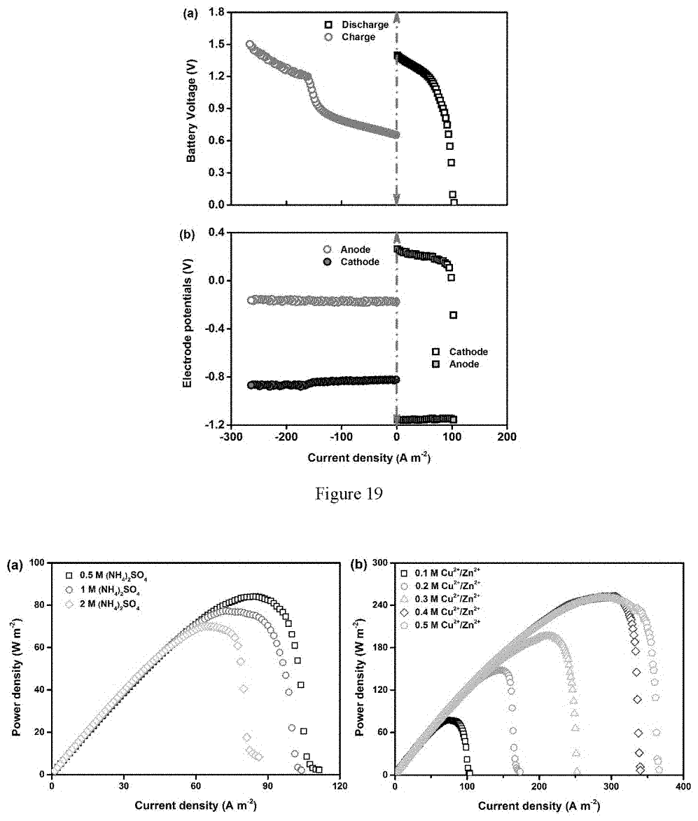

In order to confirm that the Cu/Zn-TRAFB system can realize high-voltage discharge and low-voltage charge, preliminary tests were carried out on the charge and discharge characteristics with fresh electrolytes and without thermal regeneration. FIG. 19 showed the discharge and charge voltages and corresponding electrode potentials as a function of current densities. The discharge voltage gradually decreased with increasing current density. The main reason for the rapid decline of the voltage at the end of discharge was the sharp decrease of the deposition potential of Cu²⁺, due the depletion of the Cu²⁺ concentration on the electrode surface at higher current densities. The charge voltage increased with increasing current density. The cathode potential during charging was around −0.82 V, demonstrating that deposition of Zn²⁺ occurred instead of hydrogen evolution reaction. The open circuit voltages of the discharge and charge were about 1.4 V and 0.65 V respectively, so a voltage difference of 0.75 V can be used for net energy outputs (FIG. 19(a)). As the current density increased, the voltage difference gradually decreased. However, as long as the charging current density was small enough (<50 A m⁻²), the Cu/Zn-TRAFB at most of the discharging conditions could achieve high-voltage discharge and low-voltage charge.

Optimization of Electrolyte Concentrations

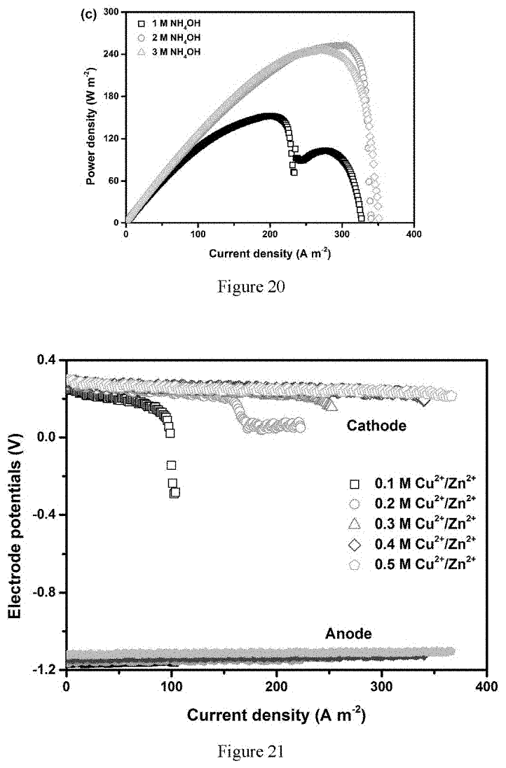

The battery power density in the discharge process is a key parameter to evaluate the ability of a technology to convert waste heat into electrical energy. Therefore, the influences of the concentrations of (NH₄)₂SO₄, Cu²⁺/Zn²⁺ and NH₄OH on the power productions of a single Cu/Zn-TRAFB were investigated. (NH₄)₂SO₄ is used as the supporting electrolyte, and its main function is to promote the conductivity of the solution and reduce the internal resistance of the battery. But at the same time, its presence will produce a reaction resistance, which is bad for power outputs and limits the excessive increase in its concentration. Additionally, ionized NH₄⁺ helps to inhibit the ionization of NH₄OH and enhance the activity of NH₃. As shown in FIG. 20(a), increasing the (NH₄)₂SO₄ concentration from 1 M to 2 M, the peak power density was reduced from 77 W m⁻² to 70 W m⁻². When the concentration of (NH₄)₂SO₄ was lowered from 1 M to 0.5 M, the peak power density was improved from 77 W m⁻² to 84W m⁻². These results showed that the increase of ohmic resistance of the electrolytes had little effect on the power production, and the increasing reaction resistance at higher concentrations was the decisive factor. Increasing the concentration of Cu²⁺/Zn²⁺ from 0.1 M to 0.4 M significantly enhanced the peak power density (77W m⁻², 0.1 M; 148W m⁻², 0.2 M; 196W m⁻², 0.3 M;252W m⁻², 0.4 M, FIG. 20(b)), which was mainly owing to improved cathode potentials with increasing Cu²⁺ concentrations (see FIG. 21). Continuing to increase the concentration of Cu²⁺/Zn²⁺ to 0.5 M did not further increase the peak power density. The cathode potential was no longer enhanced, but the concentration of free NH₃ in anolyte was decreased at higher Zn²⁺ concentration, making the anode potential shift positively and thereby limiting further improvement in power production (FIG. 21). When the concentration of NH₄OH was reduced from 2 M to 1 M, the peak power density decreased from 252 W m⁻² to 152 W m⁻², but a higher NH₄OH concentration of 3 M led to a slight deterioration of peak power density to 247 W m⁻² (FIG. 20(c)). Higher NH₄OH concentrations contributed to promote the anode performance, but ionized more OH⁻. The OH⁻ and NH₃ molecules could permeate through the anion exchange membrane and react with Cu²⁺ in catholyte, resulting in self-discharge and weakening the power outputs.

Based on the above experimental results, the optimal combination of electrolyte concentrations for Cu/Zn-TRAFB were 0.5 M (NH₄)₂SO₄, 0.4 M Cu²⁺/Zn²⁺ and 2 M NH₄OH, which was different from the results of Cu/Zn-TRAB (1 M (NH₄)₂SO₄, 0.1 M Cu²⁺/Zn²⁺ and 2 M NH₄OH). For (NH₄)₂SO₄, since the spacing of electrodes in flow battery was only 3 mm (compared to the 20˜25 mm for previous Cu/Zn-TRAB), a smaller supporting electrolyte concentration could be used without being affected by a larger ohmic resistance. However, 0.5 M (NH₄)₂SO₄ would cause the anolyte to ionize more OH⁻, and some blue precipitates attached to the cathodic side of AEM after the test. Considering that the concentration of (NH₄)₂SO₄ had a relatively small impact on power output, 1 M (NH₄)₂SO₄ was selected as the supporting electrolyte in subsequent experiments.

Effect of Flow Rate on Power Output

FIG. 22 showed the peak power density of a single Cu/Zn-TRAFB cell at different electrolyte flow rates. When the flow rate was increased from 1 mL min⁻¹ to 8 mL min⁻¹, the peak power density was improved from 252 W m⁻² to ˜280 W m⁻², mainly due the accelerated mass transfer within the flow channels. But a further increase of flow rate to 20 mL min⁻¹, the peak power output was approximately the same, which was owing to the limitation of the reaction kinetic rate under sufficient mass transfer. In this flow battery system, the Reynolds number (Re) was about 11 at a flow rate of 20 mL min⁻¹, so the electrolyte flows could be regarded as laminar flow. At large flow rates, the flow pressure drop increased, causing power loss. According to the formulas of pressure drop and power loss

$$( Δ P = \frac{12 µL {Q}_{f}}{{bd}^{3}} and {P}_{loss} = \frac{2 {Q}_{f} Δ P}{A} ) ,$$

the pressure drop was only about 0.2 Pa at a flow rate of 20 mL min⁻¹ and the corresponding power loss was 7×10⁻⁵ W m⁻², which was negligible. The reason for the smaller pressure drop was that the thickness of the flow channel was 1.5 mm and relatively large. The peak power density of 280 W m⁻² based on the membrane area was greatly enhanced compared to the 120 W m⁻² previously obtained by a Cu/Zn-TRAB, which meant that with same membrane area (or cost, because the cost of the membrane in this battery system was the highest), Cu/Zn-TRAFB could provide more than twice the power output. The peak power density achieved by Cu/Zn-TRAFB normalized to the reactor volume was 93 kW m⁻³, which had a significant improvement over the 1.5 kW m⁻³ obtained with Cu/Zn-TRAB, mainly attributed to the compact battery structure design.

Net Energy Production and Energy Conversion Efficiency

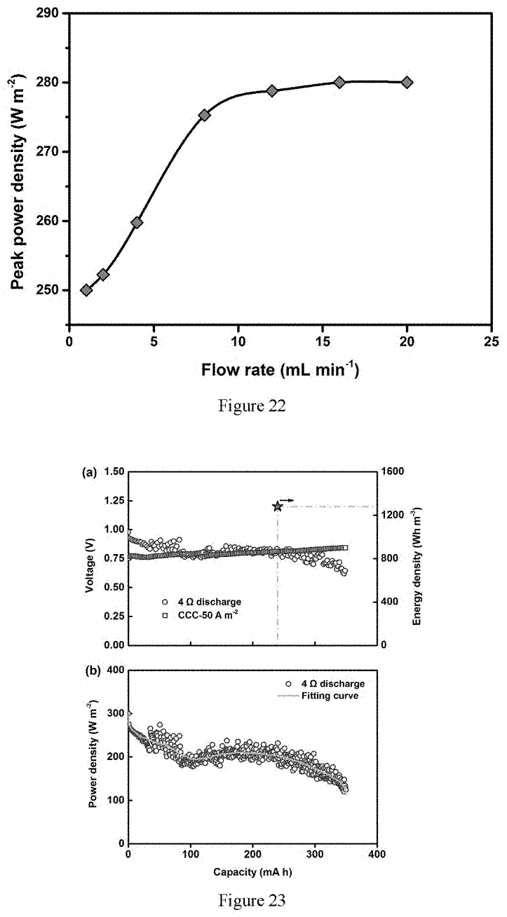

The net energy density of the Cu/Zn-TRAFB at peak power output was examined with optimum electrolyte concentrations and flow rate (FIG. 23). The peak power density reached ˜280 W m⁻² during discharging (FIG. 23(b)). The constant load discharge increased the discharge current and greatly reduced the battery voltage to 0.98 V, which extremely weakened the discharge energy density (FIG. 23(a)). As the discharge capacity increased, the discharge voltage gradually decreased. The charge voltage was 0.76 V with a constant current density of 50 A m⁻² and increased with charge capacity. When the capacity was 240 mA h, the net energy density reached the maximum value of 1280 Wh m_{anolyte}⁻³, which was higher than 598 Wh m_{anolyte}⁻³ (299 Wh m_{total electrolyte}⁻³ with the maximum power density of 120 W m⁻²) received by the Cu/Zn-TRAB, primarily due the higher Cu²⁺ concentration. Discharging with a lower current density can significantly boost the net energy density, but the power output will be reduced. In addition, a lower charging current density also helps lower the charge voltage and increase the net energy density.

By measuring the mass change of electrodes before and after the experiments, the cathodic and anodic coulombic efficiencies during discharging were calculated to be about 100% and 80% , respectively. It was showed that there was no side reactions in the deposition process of Cu²⁺, and excess zinc was oxidized. The cathodic coulombic efficiency during the charge process was approximately 115% , and the anodic coulombic efficiency was about 32% . It indicated that the deposition of Zn²⁺ mainly occurred in the cathode, and the part higher than 100% may be due to the adsorption of a small amount of Zn(OH)₂ on the surface of Zn electrode, resulting in slightly heavier electrode mass. As the OH⁻ and NH₃ molecules passed through the membrane, some Zn(OH)₂ was formed and absorbed on Zn electrode at the end of charge, and this phenomenon was observed after the test. The anodic coulombic efficiency of copper was lower, and the main reason was that Cu(NH₃)₄²⁺ was partially reduced to Cu(NH₃)₄⁺ during the oxidation of copper. As shown by cyclic voltammetry (CV) curves in FIG. 24(a), the first reduction peak had begun to form during the formation process of oxidation peak, and the occurrence of reduction current could offset a portion of the oxidation charge and led to a lower coulombic efficiency. The coulombic efficiency of Zn as the anode was much higher that of Cu anode. From the CV curves, it was found that there was no reduction peak near the potential of Zn oxidation peak (FIG. 24(b)). However, the coulombic efficiency of Zn anode is not 100% , which is not unilateral and needs be explored in future.

Based on a distillation column model established in Aspen HYSYS, the thermal energy required to separate 2 M NH₃ from the anolyte in a closed cycle was about 372 kW h m_{anolyte}⁻³. The distillation column has an inlet temperature (Tᵢₙ) of 27° C., a reboiler temperature (T_{R}) of 70.9° C. and a condenser temperature (T_{C}) of 43° C. The calculated thermoelectric conversion efficiency was 0.34% (2.7% relative to the Carnot efficiency) in the case of maximum power output, which met the necessary condition for the commercial application of technologies to convert thermal energy into electricity (the Carnot-relative efficiency reached the range of 2%˜5% ).At the maximum power output, the energy density is relatively small. The method of enhancing the net energy density was also suitable for improving the thermal energy efficiency. Moreover, if the inlet temperature of distillation column was raised to 50° C. and the condenser temperature was lowered to 34° C., the energy conversion efficiency could be increased to 1.64% (27% relative to the Carnot efficiency), indicating that the distillation parameters had a decisive effect.

Scalability of Cu/Zn-TRAFB

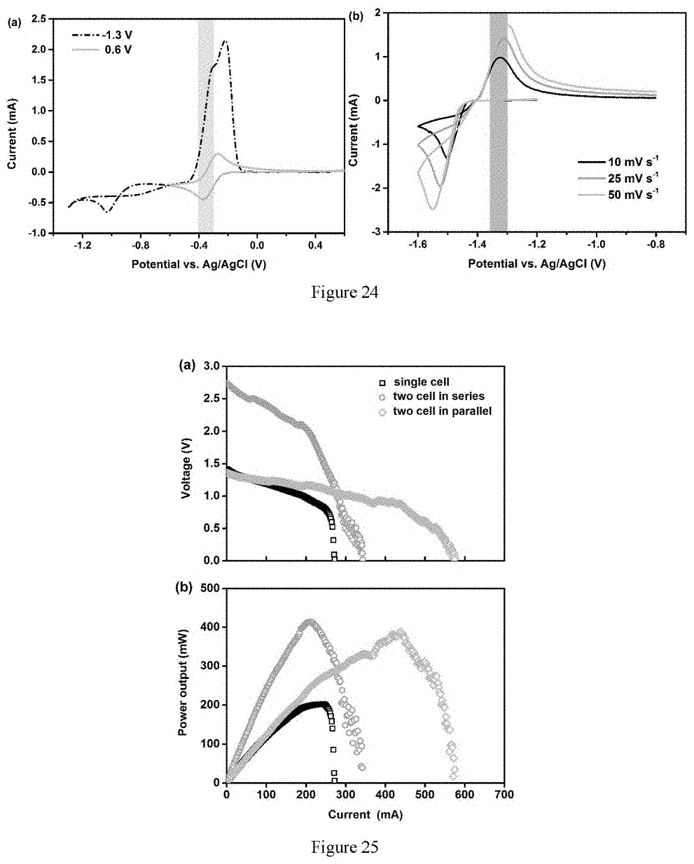

To examine the scalability of this flow battery system, the performance of two Cu/Zn-TRAFB cells connected in series and parallel was investigated. FIG. 18(c) and (d) showed the connections of two cells in parallel and series. The catholyte and anolyte flowed into the two cells separately through the peristaltic pumps, and the effluent electrolytes were collected and flowed back to the respective reservoirs. Two cells were connected in series for increasing the voltage of the entire battery system to 2.75 V, which was about twice the single cell voltage of 1.4 V, and the difference in maximum current was small (FIG. 25(a)). The parallel connection of two cells approximately doubled the maximum current from 272 mA to 574 mA, and the whole battery voltage did not change (FIG. 25(a)). Whether operated in series or parallel, the maximum power output of the entire battery was about twice that of the single cell (201 mW, single cell; 412 mW, two cells in series; 390 mW, two cells in parallel, FIG. 25(b)). Therefore, the Cu/Zn-TRAFB system can meet the actual demands for output voltage and current by adding battery modules connected in series or parallel.

System Stability and Electrode Reversibility

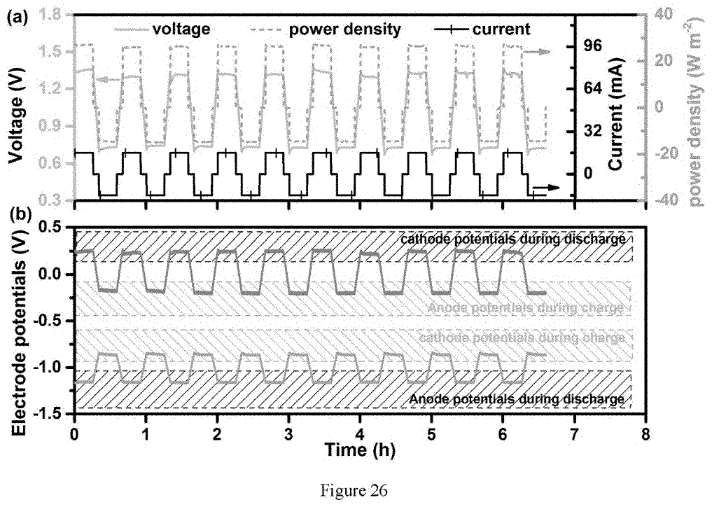

The Cu/Zn-TRAFB system needs to work in a continuous mode of closed cycles, in which the catholyte and anolyte flow through the system circularly and copper and zinc electrodes also undergo cyclic oxidation and reduction reactions. Therefore, the stability of battery system performance and redox reversibility of the electrodes were investigated in 10 cycles (FIG. 26). The cell was discharged and charged for 15 min alternately at a constant current of 16 mA, and there was 5 min interval between the discharge and charge cycles to drain the electrolytes in the system and exchange the flow paths of the catholyte and anolyte. Previous studies had demonstrated that the thermal regeneration process could be implemented and it also had been performed in energy testing experiments, so no regenerated electrolytes were used in this tests. Besides, in order, to eliminate the influence of electrolyte concentration changes on voltage and power output, fresh and identical electrolytes were used for each discharge or charge cycle. In discharge cycles, the Cu²⁺ was deposited to Cu on copper electrode, and the zinc electrode was oxidized under the effect of NH₃. Both the maximum discharge voltage and the peak power density were stable at 1.34±0.02 V and 27±1 W m⁻² (FIG. 26(a)). The maximum values of discharge cycle 1 and 6 were slightly higher, because the flow paths were flushed with ultrapure water after the fifth charge cycle, excluding the impacts of residual NH₃. During the charge process, the copper electrode was oxidized and the Zn²⁺ was reduced on the zinc electrode. It was seen from FIG. 26(a) that the minimum charge voltage and input power were uniform at about 0.7±0.02 V and 14±0.5 W m⁻², respectively. The above results indicated that the system performance remained relatively stable in successive cycles. The maximum value of the deposition potential of the cathodic Cu²⁺ in discharge cycles was about 0.26±0.01 V, and the most negative value of Zn anode potential was also around at −1.16±0.01 V (FIG. 26(b)). Correspondingly in the charge cycles, the most positive values of the Zn²⁺ deposition potential and Cu oxidation potential were stable at −0.84±0.005 V and −0.16±0.01 V, respectively (FIG. 26(b)). These results demonstrated that the copper and zinc electrodes maintained good reversibility in the cyclic oxidation and reduction reactions. While the invention has been described above with the drawings, the invention is not limited to the specific embodiments described above, and the specific embodiments described above are merely illustrative and not restrictive. Many variations are possible without departing from the purpose of the invention, and these are within the protection of the invention.

1. A bimetallic thermally regenerative ammonia-based battery system includes a reactor composed of a first electrode chamber and a second electrode chamber, a separator interposed between the first electrode chamber and the second electrode chamber. The first electrode M₁ and the second electrode M₂ are placed in the first and second electrode chambers, respectively, where the reference electrodes are also placed separately. Both the first electrode M₁ and the second electrode M₂are mainly composed of the metal M, which can form complexes with ammonia, and the electrode potential of M(NH₃)ₓ^{y+}/M is less than the electrode potential of M^{y+}/M. A loop is formed by wire connection between the first and second electrodes. It is characterized in that the first electrode M₁ and the second electrode M₂ are respectively selected from different metals M, and M is taken from at least one of copper, silver, cobalt or nickel in a solid form and also includes zinc in a solid form particularly. The electrode potential M₁(NH₃)ₓ₁^{y1+}/M₁ of the first electrode M₁ is smaller than the electrode potential M₂^{y2+}/M₂ of the second electrode M₂, and the electrode potential M₁^{y1}/M₁ of the first electrode M₁ is smaller than the electrode potential M₂(NH₃)ₓ₂^{y2+}/M₂ of the second electrode M₂. The electrolyte in the first electrode chamber contains an ammonium salt and a salt of the first electrode M₁, and the electrolyte in the second electrode chamber contains an ammonium salt and a salt of the second electrode M₂.

2. The system of claim 1, wherein the first electrode M₁ and the second electrode M₂ are composite electrodes and mainly consist of at least two of Ag, Cu, Co, Ni or Zn.

3. The system of claim 1, wherein the first electrode M₁ and the second electrode M₂ are composite carbon electrodes coated with at least one of Ag, Cu, Co, Ni or Zn.

4. The system of claim 1, wherein the reactor is provided with one or more seals to secure, seal, and prevent air from entering the reactor.

5. A method of use of a bimetallic thermally regenerative ammonia-based battery system according to claim 1, comprising the steps of:
1) Adding ammonia to the first electrode chamber, thereby the battery discharging:
(a) Oxidation reaction occurs on the first electrode M₁ in the first electrode chamber: M₁ (s)+x1 NH₃ (aq)→M₁(NH₃)ₓ₁^{y1+}+y1 e⁻
(b) Reduction reaction occurs on the second electrode M₂ in the second electrode chamber: M₂^{2y+} (aq)+y2 e⁻→M₂ (s);
2) After the end of the discharge, the waste heat is used to separate the NH₃ in the first electrode chamber: M₁(NH₃)ₓ₁^{y1+} [symbol] M₁^{y1+} (aq)+x1 NH₃ (g);
The separated NH₃ is passed into the second electrode chamber, and the cathode and anode chambers are switched;
3) Charging:
(a) Reduction reaction occurs on the first electrode M₁ in the first electrode chamber: M₁^{y1+} (aq)+y1 M₁ (s)
(b) Oxidation reaction occurs on the second electrode M₂ in the second electrode chamber: M₂ (s)+x2 NH₃ (aq)→M₂(NH₃)ₓ₂^{y2+}+y2 e⁻;
4) After the end of the charge, the waste heat is used to separate the NH₃ in the second electrode chamber: M₂(NH₃)ₓ₂^{y2+} [symbol] M₂^{y2+} (aq)+x2 NH₃(g);
The separated NH₃ is passed into the first electrode chamber, and the cathode and anode chambers are switched again;
Start the second discharge cycle and repeat steps 1) to 3) above.

6. The method of claim 5, wherein when the first electrode M₁ or the second electrode M₂ is Cu, Co, Ni or Zn, the electrolyte in their respective electrode chamber is ammonium sulfate ((NH₄)₂SO₄) and the corresponding metal sulfate (MSO₄).

7. The method of claim 5, wherein when the first electrode M₁ or the second electrode M₂ is Cu, Co, Ni or Zn, the electrolyte in their respective electrode chamber is ammonium nitrate (NH₄NO₃) and the corresponding metal nitrate (M(NO₃)₂).

8. The method of claim 5, wherein when the first electrode M₁ or the second electrode M₂ is Cu, Co, Ni or Zn, the electrolyte in their respective electrode chamber is a mixture of ammonium sulfate ((NH₄)₂SO₄), ammonium nitrate (NH₄NO₃) and the corresponding metal sulfate (MSO₄) and nitrate (M(NO₃)₂).

9. The method of claim 5, wherein when the first electrode M₁ or the second electrode M₂ is Ag, the electrolyte is ammonium nitrate (NH₄NO₃) and silver nitrate (AgNO₃).

10. The method of claim 5, wherein the first electrode M₁ or the second electrode M₂ is flow electrode.

11. The method of claim 5, wherein an oxygen-free inert gas is introduced into the electrolyte to remove oxygen and inhibit electrode corrosion.

12. A bimetallic thermally regenerative ammonia-based flow battery system comprises at least one cell module, a first electrolyte tank, a second electrolyte tank, and two pumps between the cell module and the electrolyte tanks connected by pipelines. Electrolytes are stored in the first electrolyte tank and the second electrolyte tank, and a reference electrode is disposed between the pump and the cell module. The cell module is mainly composed of a first electrode M₁, a second electrode M₂, a first electrode chamber, a second electrode chamber, and a separator interposed between the first and second electrode chambers. Both the first electrode M₁ and the second electrode M₂ are mainly composed of the metal M, which can form complexes with ammonia, and the electrode potential of M(NH₃)ₓ^{y+}/M is less than the electrode potential of MYVM. A loop is formed by wire connection between the first and second electrodes. The first and second electrolyte tanks are located on two sides of the cell module, respectively, and the electrolytes in the first and second electrode chambers are continuously flowing. It is characterized in that the first electrode M₁ and the second electrode M₂ are respectively selected from different metals M, and y is taken from at least one of copper, silver, cobalt or nickel in a solid form and also includes zinc in a solid form particularly. The electrode potential M₁(NH₃)ₓ₁^{y1+}/M₁ of the first electrode M₁ is smaller than the electrode potential M₂^{y2+}/M₂ of the second electrode M₂, and the electrode potential M₁^{y1+}/M₁ of the first electrode M₁ is smaller than the electrode potential M₂(NH₃)ₓ₂^{y2+}/M₂ of the second electrode M₂. The electrolyte in the first electrolyte tank contains an ammonium salt and a salt of the first electrode M₁, and the electrolyte in the second electrolyte tank contains an ammonium salt and a salt of the second electrode M₂.

13. The system of claim 12, wherein the first electrode M₁ and the second electrode M₂ are composite electrodes and mainly consist of at least two of Ag, Cu, Co, Ni or Zn.

14. The system of claim 12, wherein the first electrode M₁ and the second electrode M₂ are composite carbon electrodes coated with at least one of Ag, Cu, Co, Ni or Zn.

15. The system of claim 12, wherein the cell module is provided with one or more seals to secure, seal, and prevent air from entering the cell module.

16. A method of use of a bimetallic thermally regenerative ammonia-based flow battery system, according to claim 12, comprising the steps of:
1) Adding ammonia to the first electrolyte tank, thereby the battery discharging:
(a) Oxidation reaction occurs on the first electrode M₁ in the first electrode chamber: M₁ (s)+x1 NH₃ (aq)→M₁(NH₃)ₓ₁^{y1+}+y1 e⁻
(b) Reduction reaction occurs on the second electrode M₂ in the second electrode chamber: M₂^{Y2+} (aq)+y2 e⁻→M₂ (s);
2) After the end of the discharge, the waste heat is used to separate the NH₃ in the first electrolyte tank: M₁(NH₃)ₓ₁^{y1+} [symbol] M₁^{y1+} (aq)+x1 NH₃ (g);
The separated NH₃ is passed into the second electrolyte tank, and the cathode and anode chambers are switched;
3) Charging:
(a) Reduction reaction occurs on the first electrode M₁ in the first electrode chamber: M₁^{y1+} (aq)+y1 e⁻→M₁ (s)
(b) Oxidation reaction occurs on the second electrode M₂ in the second electrode chamber: M₂ (s)+x2 NH₃ (aq)→M₂(NH₃)ₓ₂^{y2+}+y2 e⁻;
4) After the end of the charge, the waste heat is used to separate the NH₃ in the second electrolyte tank: M₂(NH₃)ₓ₂^{y2+} [symbol] M₂^{y2+} (aq)+x2 NH₃ (g);
The separated NH₃ is passed into the first electrolyte tank, and the cathode and anode chambers are switched again;
Start the second discharge cycle and repeat steps 1) to 3) above.

17. The method of claim 16, wherein when the first electrode M₁ or the second electrode M₂ is Cu, Co, Ni or Zn, the electrolyte in their respective electrolyte tank is ammonium sulfate ((NH₄)₂SO₄) and the corresponding metal sulfate (MSO₄).

18. The method of claim 16, wherein when the first electrode M₁ or the second electrode M₂ is Cu, Co, Ni or Zn, the electrolyte in their respective electrolyte tank is ammonium nitrate (NH₄NO₃) and the corresponding metal nitrate (M(NO₃)₂).

19. The method of claim 16, wherein when the first electrode M₁ or the second electrode M₂ is Cu, Co, Ni or Zn, the electrolyte in their respective electrolyte tank is a mixture of ammonium sulfate ((NH₄)₂SO₄), ammonium nitrate (NH₄NO₃) and the corresponding metal sulfate (MSO₄) and nitrate (M(NO₃)₂);
wherein when the first electrode M₁ or the second electrode M₂ is Ag, the electrolyte is ammonium nitrate (NH₄NO₃) and silver nitrate (AgNO₃).

20. The method of claim 16, wherein the first electrode M₁ or the second electrode M₂ is flow electrode;
the first electrode chamber and the first electrolyte tank are connected;
the second electrode chamber and the second electrolyte tank are connected;
an oxygen-free inert gas is introduced into the first or second electrolyte tanks to remove oxygen and inhibit electrode corrosion.
